(19) United States
(12) Patent Application Publication
(10) Pub. No.: US 2021/0053275 A1
(43) Pub. Date: Feb. 25, 2021

(54) APPARATUSES, METHODS AND SYSTEMS FOR PRINTING THREE-DIMENSIONAL OBJECTS

(71) Applicant: Digital Alloys Incorporated, Burlington, MA (US)

(72) Inventors: Paul Burke, Framingham, MA (US); Elad Taig, Lexington, MA (US); Mateo Pena Doll, San Francisco, CA (US); Duncan McCallum, Lexington, MA (US)

(21) Appl. No.: 16/999,731

(22) Filed: Aug. 21, 2020

Related U.S. Application Data
(63) Continuation of application No. PCT/US19/22785, filed on Mar. 18, 2019.
(60) Provisional application No. 62/644,990, filed on Mar. 19, 2018.

(51) Int. Cl. B29C 64/112; B29C 64/209; B29C 64/393; B29C 64/295; B33Y 50/02; B33Y 10/00; B33Y 30/00

(52) U.S. Cl. CPC B29C 64/112; B29C 64/209; B29C 64/393; G06F 2113/10; B33Y 50/02; B33Y 10/00; B33Y 30/00; B29C 64/295

(57) ABSTRACT

The present disclosure provides a method for printing a three-dimensional object, comprising calculating at least one deposition parameter based on a computational representation of the 3D object, and using a print head to initiate printing in accordance with the deposition parameter. The printing comprises subjecting at least one feedstock to heating upon flow of electrical current through the feedstock and into the base, or vice versa. Next, (i) one or more properties of the 3D object or feedstock may be measured and (ii) whether the one or more properties of the 3D object measured in (i) meet one or more predetermined properties of the 3D object or the feedstock may be determined. The deposition parameter may be adjusted upon determining that the properties measured do not meet the predetermined properties. The print head and the adjusted deposition parameter may be used to continue to print the 3D object.

### CROSS-REFERENCE

This application is a bypass continuation of International Patent Application No. PCT/US19/22785, filed Mar. 18, 2019, which claims priority to U.S. Provisional Patent Application No. 62/644,990, filed Mar. 19, 2018, each of which is entirely incorporated herein by reference.

### BACKGROUND

Existing technologies for the additive manufacture of metal structures may generally be classified in three categories: powder bed fusion (for example, direct metal laser sintering), adhesive powder bonding followed by sintering, and molten metal deposition.

Powder bed fusion technologies comprise a bed of metal powder in the build area, and a laser or electron beam may be applied to the powder particles to selectively join them to one another to form the appropriate pattern. When one layer is completed, more metal powder may be spread over the first layer, and powder particles can be joined to the previous layer in the appropriate pattern for that layer. The process can continue with fresh powder spread over the entire surface of the build area and then selectively joined, building the structure layer by layer. The finished part may be retrieved from inside the powder bed, and the powder can then be emptied from the build area to begin the next part. However, conventional uses of metal powder as a raw material may be problematic. Metal powder can be expensive to produce, and generally is more expensive than a wire made from the same material for the same volume of material. Metal powders may be difficult and dangerous to handle. For example, metal powder that is spilled may form dust in the air that is dangerous to inhale, and such dust may even be an explosion risk. In addition, the amount of powder required for powder bed fusion additive manufacturing technologies may be many times greater than that required to make the part, as the entire build area can be filled with powder. This may increase the cost of the process and can lead to attrition and waste of powder, which may not be readily reused. Conventional powder-based processes may also be very slow because the spreading of concurrent layers of powder can be done precisely to the required layer thickness, and because adding heat with a laser or electron beam to fuse a powder can be comparatively slow and inefficient.

Powder bed fusion may use a high power laser or electron beam as the source of heat to fuse particles. Such a process can have many safety risks, especially at the powers required for fusing metals. Furthermore, the melting of powder using a laser or electron beam can require much more heat as compared to heat applied directly to the joining surfaces, which may slow down the overall process and cause the excess heat to be dissipated into the powder bed. As a result, there may be the danger of unwanted sintering particles in the area around that which the laser is heating. The process may be more applicable to metals and alloys that have poor heat conduction.

Adhesive bonding may use binder to join adjacent powder particles instead of directly fusing the particles by heating them. Binder can be selectively sprayed to form a pattern, and powder may be added layer by layer to form the structure, often referred to as a “green part”. In an alternate form, the binder and powder mixture can be extruded from a print head. To make a mechanically sound metal part, the green part generally can be removed from the powder bed, the glue removed, and the part placed in a furnace to sinter the bonded metal powders. The sintering can multiply the complexity of the process as well as the time required to produce parts. For thicker parts, it may be difficult to remove all of the binder, or to sinter the powder-based parts to full density and strength. In addition, the volume that was occupied by the binder can become a void in the metal part. When parts are sintered, they may shrink to fill such voids making it difficult to maintain accurate shapes.

In molten-metal deposition techniques, heat to liquefy the metal is derived from plasma, electric arc, or laser beam. The molten metal is then sprayed or dripped in the pattern to form a structure by building layers as the metal cools. The resolution achieved by spraying or dripping metal is generally poor compared to other processes. In addition, because the metal is sprayed or dripped, the geometries that can be deposited are limited.

### SUMMARY

In another aspect, the present disclosure provides a method for printing a three-dimensional (3D) object adjacent to a base, comprising: (a) calculating at least one deposition parameter based at least in part on a computational representation of the 3D object; (b) using a print head to initiate printing of the 3D object in accordance with the at least one deposition parameter, wherein the printing comprises subjecting at least one feedstock to heating upon flow of electrical current through the at least one feedstock and into the base, or vice versa, which heating is sufficient to melt at least a portion of the at least one feedstock; (c) while printing the 3D object with the print head, (i) measuring one or more properties of the 3D object or the at least one feedstock and (ii) determining whether the one or more properties of the 3D object measured in (i) meet one or more predetermined properties of the 3D object or the at least one feedstock; (d) adjusting the at least one deposition parameter upon determining that the one or more properties of the 3D object or the at least one feedstock measured in (c) do not meet the one or more predetermined properties, to yield at least one adjusted deposition parameter; and (e) using the print head and the at least one adjusted deposition parameter to continue to print the 3D object.

In some embodiments, the one or more predetermined properties is generated by simulating the 3D object. In some embodiments, the simulating includes finite element analysis. In some embodiments, the simulating is performed prior to printing the 3D object. In some embodiments, the at least one deposition parameter is adjusted in real time while the 3D object is being printed.

In some embodiments, the at least one feedstock is a metal wire or a multi-metal wire. In some embodiments, the multi-metal wire is a tubular multi-metal wire. In some embodiments, the at least one deposition parameter is a tool path trajectory or a process parameter usable by the print head for printing the 3D object. In some embodiments, the measuring in (c) comprises measuring at least one deposition parameter of the base or environment in which the 3D object is being generated. In some embodiments, (c) further comprises using one or more sensors to measure the one or more properties of the 3D object. In some embodiments, the one or more sensors is selected from the group consisting of camera, infrared sensors, photo detector, optical pyrometer, optical emission spectrometer, thermocouple, thermistors, frequency response analyzer, magnetometer, gas flow sensor, accelerator, weight measure, contact force sensor, position sensor, electrical energy sensor, electrical resistance sensor, inductance sensor, and capacitance sensor.

In some embodiments, the measuring comprises using one or more members selected from the group consisting of optical pyrometry, infrared thermography, spectroscopy, laser ultrasonics, weight measurement, contact force measurement, position measurement, electrical energy measurement, electrical resistance measurement, inductance measurement, and capacitance measurement. In some embodiments, the one or more properties comprises one or more members selected from the group consisting of modulation signal, mass, thermal mass, mass flow rate of the at least one feedstock, chamber temperature, heat capacity, surface temperature, current, voltage, contact force of the tip of the least one feedstock, and amount of the at least one feedstock. In some embodiments, the modulation signal is pulse width modulation.

In some embodiments, the at least one deposition parameter comprises one or members selected from the group consisting of resistance of the at least one feedstock or at least a portion of the 3D object, contact force of the at least one feedstock, geometry of the at least one feedstock, geometry of at least a portion of the 3D object, position of the at least one feedstock, position of at least a portion of the 3D object, position of the print head and the base, position of the print head and a previous layer, amount of the feedstock used during the printing, electrical energy output of the printing, current, voltage applied between the at least one feedstock and the base, electrical resistance parameter, inductance of the at least one feedstock or at least a portion of the 3D object, and capacitance of the at least one feedstock or at least a portion of the 3D object. In some embodiments, the at least one deposition parameter is energy or mass of the 3D object or the at least one feedstock. In some embodiments, the at least one deposition parameter corresponds to an energy or mass of at least one voxel of the 3D object or the at least one feedstock. In some embodiments, (c) further comprises computing the energy or the mass of the 3D object or the at least one feedstock. In some embodiments, the method for printing the 3D object further comprises storing the energy or the mass of the 3D object or the at least one feedstock in computer memory. In some embodiments, (d) comprises controlling a mass of the 3D object or the at least one feedstock. In some embodiments, (d) comprises controlling a deposition rate or mass flow rate during the printing the 3D object. In some embodiments, the heating is Joule heating.

In another aspect, the present disclosure provides a system for printing a three-dimensional (3D) object adjacent to a base, comprising: a print head configured to print the 3D object; and one or more computer processors operatively coupled to the print head, wherein the one or more computer processors are individually or collectively programmed to: (i) calculate at least one deposition parameter based at least in part on a computational representation of the 3D object; (ii) direct the print head to initiate printing of the 3D object in accordance with the at least one deposition parameter, wherein the printing comprises subjecting at least one feedstock to heating upon flow of electrical current through the at least one feedstock and into the base, or vice versa, which heating is sufficient to melt at least a portion of the at least one feedstock; (iii) while printing the 3D object with the print head, (1) measure one or more properties of the 3D object or the at least one feedstock and (2) determine whether the one or more properties of the 3D object measured in (1) meet one or more predetermined properties of the 3D object or the at least one feedstock; (iv) adjust the at least one deposition parameter upon determining that the one or more properties of the 3D object or the at least one feedstock measured in (iii) do not meet the one or more predetermined properties, to yield at least one adjusted deposition parameter; and (v) use the print head and the at least one adjusted deposition parameter to continue to print the 3D object. In some embodiments, the base comprises at least one electrically conductive sheet secured to a support.

In another aspect, the present disclosure provides a method for printing a three-dimensional (3D) object, comprising: (a) providing a base for supporting the 3D object during the printing, and at least one electrically conductive sheet secured to the base; and (b) printing the 3D object secured to the at least one electrically conductive sheet, which printing comprises subjecting at least one feedstock in contact with the at least one electrically conductive sheet to heating upon flow of electrical current through the at least one feedstock and into the at least one electrically conductive sheet, or vice versa.

In some embodiments, the heating is Joule heating. In some embodiments, the printing comprises moving the at least one feedstock relative to the at least one electrically conductive sheet while subjecting the electrical current to flow through the at least one feedstock and into the at least one electrically conductive sheet, or vice versa. In some embodiments, the base is electrically conductive.

In another aspect, the present disclosure provides a system for printing a three-dimensional (3D) object, comprising: a base for supporting the 3D object during the printing; at least one electrically conductive sheet that is secured to the base and to which the 3D object is secured during the printing; and at least one controller that is configured to subject at least one feedstock to heating upon flow of electrical current through the at least one feedstock and into the electrically conductive sheet, or vice versa.

In some embodiments, the base is electrically conductive. In some embodiments, the system for printing the 3D object further comprises at least one print head on a multi-axis robotic arm for dispensing the at least one feedstock. In some embodiments, the multi-axis robotic arm is a six axis or a seven axis robotic arm. In some embodiments, the system for printing the 3D object further comprises one or more tips for shaping at least one layer of the 3D object. In some embodiments, the shaping comprises mechanical manipulation.

In some embodiments, the system for printing the 3D object further comprises a cutter for cutting a portion of the at least one feedstock during or after deposition. In some embodiments, the system for printing the 3D object further comprises one or more sensors for measuring at least one property of the 3D object. In some embodiments, the one or more sensors are external to the base. In some embodiments, the one or more sensors is selected from the group consisting of camera, infrared sensors, photo detector, optical pyrometer, optical emission spectrometer, weight measure, thermocouple, thermistor, frequency response analyzer, magnetometer, gas flow sensor, accelerator, contact force sensor, position sensor, electrical energy sensor, electrical resistance sensor, inductance sensor, and capacitance sensor.

In some embodiments, the base is a rotating cylinder or a turntable. In some embodiments, the at least one electrically conductive sheet takes the form of the base. In some embodiments, the at least one electrically conductive sheet comprises one or more members selected from the group consisting of metallic mesh, foil, and film. In some embodiments, the at least one electrically conductive sheet is formed of a material that adheres to the at least one feedstock. In some embodiments, the at least one electrically conductive sheet forms a part of the 3D object. In some embodiments, the at least one electrically conductive sheet is secured onto the base using a vacuum. In some embodiments, the base comprises holes for the vacuum. In some embodiments, the vacuum is varied to alter flow of heat or the flow of electrical current.

In some embodiments, the at least one electrically conductive sheet is non-magnetically secured to the base. In some embodiments, the base comprises holes for thermocouples and heater cartridges. In some embodiments, a toolpath for printing of at least a portion of the 3D object is adjusted by controlling at least one deposition parameter of the 3D object. In some embodiments, the at least one deposition parameter comprises one or members selected from the group consisting of resistance, contact force, geometry of the at least one feedstock, geometry of the at least the portion of the 3D object, position of the at least one feedstock, position of the at least the portion of the 3D object, position of a feeder and the electrically conductive sheet, position of the feeder and a previous layer, amount of the feedstock used during the printing, electrical energy output of the printing, current, voltage, electrical resistance parameter, inductance of the at least one feedstock or the at least the portion of the 3D object, and capacitance of the at least one feedstock or the at least the portion of the 3D object. In some embodiments, the at least one electrically conductive sheet is removably secured to the base.

In another aspect, the present disclosure provides a method for printing a three-dimensional (3D) object adjacent to a base, comprising (a) calculating at least one deposition parameter based at least in part on a computational representation of the 3D object; (b) using a print head and the at least one deposition parameter to initiate printing of the 3D object by subjecting at least one feedstock to heating upon flow of electrical current through the at least one feedstock and into the base, or vice versa, which heating is sufficient to melt at least a portion of the at least one feedstock; (c) while printing the 3D object with the print head, (i) measuring one or more properties of the 3D object or the at least one feedstock and (ii) determining whether the one or more properties of the 3D object measured in (i) meet one or more predetermined properties of the 3D object or the at least one feedstock; (d) adjusting the at least one deposition parameter upon determining that the one or more properties of the 3D object or the at least one feedstock measured in (c) do not meet the one or more predetermined properties, to yield at least one adjusted deposition parameter; and (e) using the print head and the at least one adjusted deposition parameter to continue to print the 3D object.

In some embodiments, the one or more predetermined properties is generated by simulating the 3D object. In some embodiments, simulating includes finite element analysis. Simulating may be performed prior to printing the 3D object. In some embodiments, the at least one deposition parameter is adjusted in real time while the 3D object is being printed. In some embodiments, the at least one feedstock is a metal wire or a multi-metal wire. The multi-metal wire may be a tubular multi-metal wire. In some embodiments, the at least one deposition parameter is a tool path trajectory or a process parameter usable by the print head for printing the 3D object. In some embodiments, the measuring in step (c) comprises measuring at least one deposition parameter of the base or environment in which the 3D object is being generated. In some embodiments, step (c) further comprises using one or more sensors to measure the one or more properties of the 3D object.

In some embodiments, the one or more sensors is selected from the group consisting of camera, infrared sensors, photo detector, optical pyrometer, optical emission spectrometer, thermocouple, thermistors, frequency response analyzer, magnetometer, gas flow sensor, accelerator, weight measure, contact force sensor, position sensor, electrical energy sensor, electrical resistance sensor, inductance sensor, and capacitance sensor. In some embodiments, the measuring comprises using one or more members selected from the group consisting of optical pyrometry, infrared thermography, spectroscopy, laser ultrasonics, weight measurement, contact force measurement, position measurement, electrical energy measurement, electrical resistance measurement, inductance measurement, and capacitance measurement. In some embodiments, the one or more properties comprises one or more members selected from the group consisting of modulation signal, mass, thermal mass, mass flow rate of the at least one feedstock, chamber temperature, heat capacity, surface temperature, current, voltage, contact force of the tip of the least one feedstock, and amount of the at least one feedstock. The modulation signal may be pulse width modulation. In some embodiments, the at least one deposition parameter comprises one or members selected from the group consisting of resistance of the at least one feedstock or at least a portion of the 3D object, contact force of the at least one feedstock, geometry of the at least one feedstock, geometry of at least a portion of the 3D object, position of the at least one feedstock, position of at least a portion of the 3D object, position of the print head and the base, position of the print head and a previous layer, amount of the feedstock used during the printing, electrical energy output of the printing, current, voltage applied between the at least one feedstock and the base, electrical resistance parameter, inductance of the at least one feedstock or at least a portion of the 3D object, and capacitance of the at least one feedstock or at least a portion of the 3D object. The at least one deposition parameter may be energy or mass of the 3D object or the at least one feedstock. In some embodiments, the at least one deposition parameter corresponds to an energy or mass of at least one voxel of the 3D object or the at least one feedstock. In some embodiments, step (c) further comprises computing the energy or the mass of the 3D object or the at least one feedstock. In some embodiments, step (c) further comprises storing the energy or the mass of the 3D object or the at least one feedstock in computer memory. In some embodiments, step (d) comprises controlling a mass of the 3D object or the at least one feedstock. In some embodiments, step (d) comprises controlling a deposition rate or mass flow rate during the printing the 3D object. In some embodiments, the heating is Joule heating.

In another aspect, the present disclosure provides a system for printing a three-dimensional (3D) object, comprising an electrically conductive base for supporting the 3D object during the printing; at least one sheet that is secured to the electrically conductive base and to which the 3D object is secured during the printing; and at least one controller that is configured to subject at least one feedstock to heating upon flow of electrical current through the at least one feedstock and into the electrically conductive base, or vice versa. In some embodiments, the system for printing a 3D object further comprises at least one print head on a multi-axis robotic arm for dispensing the at least one feedstock. In some embodiments, the multi-axis robotic arm is a six axis or a seven axis robotic arm. In some embodiments, the system for printing the 3D object further comprises one or more tips for shaping at least one layer of the 3D object. In some embodiments, the shaping comprises mechanical manipulation. In some embodiments, the system for printing the 3D object further comprises a cutter for cutting a portion of the at least one feedstock during or after deposition.

In some embodiments, the system for printing the 3D object further comprises one or more sensors for measuring at least one property of the 3D object. In some embodiments, the one or more sensors are external to the electrically conductive base. In some embodiments, the one or more sensors is selected from the group consisting of camera, infrared sensors, photo detector, optical pyrometer, optical emission spectrometer, weight measure, thermocouple, thermistor, frequency response analyzer, magnetometer, gas flow sensor, accelerator, contact force sensor, position sensor, electrical energy sensor, electrical resistance sensor, inductance sensor, and capacitance sensor. In some embodiments, the electrically conductive base is a rotating cylinder or a turntable.

In some embodiments, the at least one sheet takes the form of the electrically conductive base. In some embodiments, the at least one sheet comprises one or more members selected from the group consisting of metallic mesh, foil, and film. In some embodiments, the at least one sheet is formed of a material that adheres to the at least one feedstock. In some embodiments, the at least one sheet forms a part of the 3D object. In some embodiments, the at least one sheet is secured onto the electrically conductive base using a vacuum.

In some embodiments, the electrically conductive base comprises holes for the vacuum. In some embodiments, the vacuum is varied to alter flow of heat or the flow of electrical current. In some embodiments, the at least one sheet is non-magnetically secured to the electrically conductive base. In some embodiments, the electrically conductive base comprises holes for thermocouples and heater cartridges. In some embodiments, a toolpath for printing of at least a portion of the 3D object is adjusted by controlling at least one deposition parameter of the 3D object. In some embodiments, the at least one deposition parameter comprises one or members selected from the group consisting of resistance, contact force, geometry of the at least one feedstock, geometry of the at least the portion of the 3D object, position of the at least one feedstock, position of the at least the portion of the 3D object, position of a feeder and the electrically conductive base, position of the feeder and a previous layer, amount of the feedstock used during the printing, electrical energy output of the printing, current, voltage, electrical resistance parameter, inductance of the at least one feedstock or the at least the portion of the 3D object, and capacitance of the at least one feedstock or the at least the portion of the 3D object. In some embodiments, the at least one sheet is removably secured to the electrically conductive base.

In another aspect, the present disclosure provides a method for printing a three-dimensional (3D) object adjacent to a base, comprising (a) receiving in computer memory a computational representation of the 3D object; (b) using a print head to initiate printing of the 3D object by, (i) directing at least one feedstock through a feeder towards the base and (ii) flowing electrical current through the at least one feedstock and into the base, or vice versa; (c) subjecting the at least one feedstock to heating upon flow of electrical current through the at least one feedstock and into the base, or vice versa, which heating is sufficient to melt at least a portion of the at least one feedstock; (d) depositing at least one layer of the at least the portion of the at least one feedstock adjacent to the base in accordance with the computational representation of the 3D object, thereby printing the 3D object; and (e) shaping the at least one layer using one or more tips. In some embodiments, the method for printing the 3D object further comprises repeating steps (d) and (e) one or more times to deposit and shape additional portion(s) of the at least one feedstock or at least one other feedstock adjacent to the base. In some embodiments, the method for printing the 3D object further comprises subsequent to (e), changing a relative position of the one or more tips with respect to the at least one layer.

In some embodiments, step (e) is performed after printing of the 3D object. In some embodiments, step (d) comprises cutting the at least the portion of the at least one feedstock after depositing the at least one layer. In some embodiments, step (e) further comprises machining the at least one layer of the at least the portion of the at least one feedstock. In some embodiments, the machining comprises use of one or more members selected from the group consisting of computer numerical control machining, mill finishing, abrasive blasting, and polishing. In some embodiments, the printing and the machining of the 3D object are performed in the same apparatus. In some embodiments, the shaping comprises mechanical manipulation. In some embodiments, the shaping is performed by variation of one or more parameters selected from the group consisting of pressure, heat, power, and gas quantity. In some embodiments, the base is a preexisting 3D object or an electrically conductive base. In some embodiments, the one or more tips is a smearing tip or a re-melting tip.

The present disclosure provides methods and systems for fabricating metal objects layer by layer in a controlled manner utilizing one or more feedstock, enabling the manufacture of 3D structures. The one or more feedstock may include, for example, (1) a wire, ribbon or sheet, (2) a plurality of wires, ribbons or sheets, or (3) a combination of two or more of wires, ribbons and sheets (e.g., combination of wires and ribbons). Such methods and systems may not use metal powders as raw materials, may not require excess heat, may not require time-consuming and uneconomical sintering steps for solidification, and can produce improved accuracy, resolution, and part geometries.

The metal feedstock may include one or more elemental metals (e.g., an alloy) or a composite material comprising a metal and at least one non-metal. The quantity of feedstock used may be as required to form the object being fabricated, eliminating most (if not all) of the waste and/or recovery processes associated with powder-based techniques. The feedstock may be more easily handled and enables faster fabrication, as it is deployed at the exact points where the solid structure is being fabricated. The feedstock may be heated upon contact with the fabrication platform or a previous layer of the structure being fabricated via flow of electric current through the feedstock into the platform or previous layer, forming a molten droplet (or “segment”) at the point of contact. The flow may comprise a pulse of electrical current. The molten droplets may adhere in place, enabling the layer-by-layer fabrication of the part. Advantageously, the single melting/deposition step may be required, obviating the need for separate sintering steps to bond the metal segments together. In addition, current may flow through the feedstock upon contact with the fabrication platform or a previous layer of the structure being fabricated, thereby minimizing heating of the feedstock (and the structure being fabricated) preventing formation of electrical arcs at the feedstock tip and also melting the feedstock with minimum heat.

Methods and systems of the present disclosure advantageously enable heat to be generated at the point of contact between adjacent segments (i.e., between the tip of the feedstock and the fabrication platform or a previous layer of the structure being fabricated), exactly where the heat is required for fusion. This may allow for quick generation of heat at appropriate locations than that utilized in laser-heating techniques. Such generation of heat may comprise low thermal time constants. In other instances, such a generation of heat may enable faster overall processing, no risk of unwanted heating of surrounding segments, and the use of many different metals and alloys. It may also reduce safety concerns, and the build area typically is maintained at a lower temperature.

Methods and systems of the present disclosure solve problems inherent to existing approaches, such as arc welding (GMAW), resistive spot welding (RSW), and computer-aided manufacturing (CAM) technologies. Embodiments of the present disclosure utilize inert gas shielding and a fine feedstock electrode as both an electrode and source of metal feedstock, an electric current that heats and melts the feed metal and base metal due to resistance, and can control the motion of the feedstock electrode in three dimensions through a computer-controlled interface, allowing for deposition of material in the appropriate shape. These features enable the production of 3D metal structures using any of a variety of metals and metal alloys with minimal safety concerns at low cost.

The present disclosure provides a method of layer-by-layer fabrication of a three-dimensional metallic structure upon an electrically conductive base. A first layer of the structure is formed by depositing a plurality of metal segments onto the base. Each metal segment is deposited by (i) disposing a feedstock in contact with the base, and (ii) passing an electrical current through the feedstock and the base. A portion of the feedstock melts to form the metal segment on the base. One or more subsequent layers of the structure are formed by depositing pluralities of metal segments over the first layer of the structure. Each metal segment is deposited by (i) disposing the feedstock in contact with a previously deposited metal segment, and (ii) passing an electrical current through the feedstock, the previously deposited metal segment, and the base. A portion of the feedstock may melt to form the metal segment on the previously deposited metal segment.

A gas may be flowed over at least a tip of the feedstock during deposition of the metal segments. The gas may reduce or substantially prevent oxidation of the metal segments during deposition. The gas may increase a cooling rate of the metal segments during deposition. After deposition of each metal segment, a relative position of the feedstock and the base may be changed with one or more mechanical actuators (e.g., linear motors, servodrive, stepper motors, solenoids, etc.). The feedstock may comprise one or more metals. In some examples, the feedstock comprises one or more metals selected from the group consisting of steel, stainless steel, iron, copper, gold, silver, cobalt, chromium, nickel, titanium, platinum, palladium, titanium, and aluminum. The feedstock may include at least one metal and at least one non-metal (e.g., a semiconductor). The feedstock may include at least one metal and at least one polymer material. The at least one polymer material may include thermosetting polymer resin, or may be a polyaryletherketone (PAEK), polyethertherketone (PEEK), polyetherketoneketone (PEKK), polyethylene (PE), polyetherimide (PEI), polyethersulfone (PES), polysulfone (PSU), polyphenylsulfone (PPSU), polyphenylene oxides (PPOs), acrylonitrile butadiene styrene (ABS), polylactic acid (PLA), polyglycolic acid (PGA), polyamide-imide (PAI), polystyrene (PS), polyamide (PA), polybutylene terephthalate (PBT), poly(p-phenylene sulfide (PPS), polyethersulfone (PESU), polyphenylene ether, and polycarbonate (PC). The feedstock may include at least one fiber material, such as, for example, a fiber comprising carbon, carbon nanotubes, and/or graphene. Such fiber may provide reinforcement.

The density or porosity of at least a portion of the structure may be controlled by (i) altering a spacing between adjoining contact points between the feedstock and the base or underlying segments, (ii) altering a magnitude of the current applied between the feedstock and the base, and/or (iii) varying the amount of feedstock that is fed into each portion of each layer. A computational representation (e.g., model design) of a three-dimensional structure may be stored. Sets of data corresponding to successive layers may be extracted from the computational representation, and each of the forming steps may be performed in accordance with the data. A size of at least one metal segment may be selected by controlling a speed of retraction of the feedstock therefrom (e.g., during and/or after deposition). In other instances, the size of the at least one metal segment may be selected by controlling the amount and/or speed of insertion of the feedstock into the feeder (e.g., during and/or after deposition). An outer portion of the feedstock may be removed before the feedstock is melted to form at least one of the metal segments. An amount of feedstock utilized to form the first layer and the one or more subsequent layers of the structure may be tracked and/or stored. The metal segments may be formed in response to heat arising from, at least in part (e.g., substantially entirely due to), resistance at the tip of the feedstock (i.e., resistance resulting from contact between the tip of the feedstock and an underlying structure, e.g., the base, an underlying segment, or adjacent voxels).

The present disclosure provides an apparatus for the layer-by-layer fabrication of a three-dimensional metallic structure from segments formed by melting a feedstock. The apparatus includes or consists essentially of an electrically conductive base for supporting the structure during fabrication, a feedstock-feeding mechanism for dispensing feedstock over the base, one or more mechanical actuators for controlling a relative position of the base and the feedstock-feeding mechanism, a power supply for applying a current between the feedstock and the base sufficient to cause the feedstock to release a metal segment (e.g., via heat arising from resistance between the feedstock and an object in contact therewith, e.g., the base), and circuitry for controlling the one or more actuators and the power supply to create the three-dimensional metallic structure on the base from successively released metal segments.

The circuitry may include or consist essentially of a computer-based controller for controlling the one or more mechanical actuators and/or the power supply. The computer-based controller may include or consist essentially of a computer memory and a 3D rendering module. The computer memory may store a computational representation of a three-dimensional structure. The 3D rendering module may extract sets of data corresponding to successive layers from the computational representation. The controller may cause the mechanical actuators and the power supply to form successive layers deposited metal segments in accordance with the data. Feedstock may be disposed within the feedstock-feeding mechanism.

The present disclosure provides a method of layer-by-layer fabrication of a three-dimensional metallic structure upon an electrically conductive base. A sacrificial raft structure is formed by depositing a plurality of metal segments onto the base. Each metal segment is deposited by (i) disposing a first feedstock in contact with the base, and (ii) passing an electrical current through the first feedstock and the base. A portion of the first feedstock melts to form the metal segment on the base. A first layer of the structure is formed by depositing a plurality of metal segments onto the sacrificial raft structure. Each metal segment is deposited by (i) disposing a second feedstock in contact with the sacrificial raft structure, and (ii) passing an electrical current through the second feedstock, the sacrificial raft structure, and the base. A portion of the second feedstock melts to form the metal segment on the sacrificial raft structure. One or more subsequent layers of the structure are formed by depositing pluralities of metal segments over the first layer of the structure. Each metal segment is deposited by (i) disposing the second feedstock in contact with a previously deposited metal segment, and (ii) passing an electrical current through the second feedstock, the previously deposited metal segment, the sacrificial raft structure, and the base. A portion of the second feedstock melts to form the metal segment on the previously deposited metal segment.

The density and/or the porosity of the sacrificial raft structure may be less than that of the structure. The sacrificial raft structure may define one or more openings there through. The sacrificial raft structure may include, consist essentially of, or consist of a plurality of layers. A thickness of at least one of the layers of the sacrificial raft structure may be greater than a thickness of at least one of the layers of the structure. A thickness of at least one of the layers of the sacrificial raft structure may be greater than a thickness of all of the layers of the structure. A thickness of a bottom-most layer of the sacrificial raft structure (i.e., the layer of the sacrificial raft structure directly in contact with the base) may be greater than a thickness of at least one of, or even all of, the layers of the structure. After fabrication of the structure, the sacrificial raft structure may be removed from the base, and at least a portion of the structure may remain on the sacrificial raft structure. After the sacrificial raft structure is removed from the base, the sacrificial raft structure may be separated from the structure. The first and second feedstocks may include, consist essentially of, or consist of different materials (e.g., different metals). The first and second feedstocks may include, consist essentially of, or consist of the same material (e.g., the same metal). The metal segments may be formed in response to heat arising from, at least in part (e.g., substantially entirely due to), resistance at the tip of the feedstock (i.e., resistance resulting from contact between the tip of the feedstock and an underlying structure, e.g., the base, the raft, or an underlying segment).

Another aspect of the present disclosure provides a method for printing, layer-by-layer, a three-dimensional (3D) object on a support or a layer previously deposited over the support, comprising: receiving in computer memory a computational representation of the 3D object; subsequent to receiving the computational representation of the 3D object, directing at least one feedstock through an opening of a feeder until the feedstock is in contact with the support or the layer previously deposited over the support; using a power supply to flow electrical current through the at least one feedstock and into the support or the layer previously deposited over the support; subjecting the at least one feedstock and the support to Joule heating upon flow of electrical current through the at least one feedstock and into the support or the layer previously deposited over the support, which Joule heating is sufficient to melt a portion of the at least one feedstock; depositing the portion of the at least one feedstock on the support or the layer previously deposited over the support to yield a layer comprising the portion of the at least one feedstock; and repeating the subjecting and the depositing one or more times to deposit one or more additional layers of the at least one feedstock.

Another aspect of the present disclosure provides a system for printing, layer-by-layer, a three-dimensional (3D) object on a support or a layer previously deposited over the support, comprising: a source of at least one feedstock; a support configured to support the 3D object during formation; a feeder configured to direct the at least one feedstock from the source through an opening of the feeder towards the support or the layer previously deposited over the support; a power supply configured to supply flow of electrical current through the at least one feedstock and into the support or the layer previously deposited over the support; and a controller operatively coupled to the power supply, wherein the controller is configured to: (i) receive in computer memory a computational representation of the 3D object, (ii) subsequent to receiving the computational representation of the 3D object, direct the at least one feedstock through the opening of the feeder until the feedstock is in contact with the support or the layer previously deposited over the support, (iii) use the power supply to direct flow of electrical current through the at least one feedstock and into the support or the layer previously deposited over the support, (iv) subject the at least one feedstock to Joule heating upon flow of electrical current through the at least one feedstock and into the support or the layer previously deposited over the support, which Joule heating is sufficient to melt a portion of the at least one feedstock, such that the portion of the at least one feedstock deposits on the support or the layer previously deposited over the support to yield a layer comprising the portion of the at least one feedstock, (v) direct deposition of additional portion(s) of the at least one feedstock on the support by repeating (iv) one or more times to deposit one or more additional layers of the at least one feedstock.

In accordance with various teachings of the present disclosure, metal objects may be fabricated layer by layer in a controlled manner utilizing metal feedstock, enabling the manufacture of 3D structures. All of the feedstock which passes through the feeder may be used in the object being printed, eliminating most of the waste and/or recovery processes associated with powder-based techniques. The feedstock may be more easily handled. A near net shape of the at least a portion of the part may be printed.

The feedstock may be heated upon contact with the fabrication platform or a previous layer of the structure being fabricated via electric current, forming a molten segment at the point of contact. The molten droplets can adhere in place, enabling the layer-by-layer fabrication of the part. In some instances, a single melting and/or deposition step may be required, obviating the need for separate sintering steps to bond the metal segments together.

In addition, the current may be applied to the feedstock upon contact with the fabrication platform or a previous layer of the structure being fabricated, thereby minimizing heating of the feedstock (and the structure being fabricated) and preventing formation of electrical arcs at the feedstock tip. Teachings of the present disclosure utilize Joule heating to melt the feedstock. Joule heating is a rapid and efficient metal heating mechanism, which may allow for greatly increased printing speeds.

In the present disclosure, the heat may be generated at the point of contact between adjacent segments (i.e., between the tip of the feedstock and the fabrication platform or a previous layer of the structure being fabricated). Such a location coincides with where the heat is required for fusion. This results in lower heat input than that utilized in laser-heating techniques. The lower heat input can enable faster overall processing, without heating the surrounding segments. The use of Joule heating may be applicable to many different metals and alloys. It also reduces safety concerns, and the build area typically can be maintained at a lower temperature.

The present disclosure also provides a feedback unit that accurately measures and controls the position of the feedstock, feed rate of the feedstock, and current going through the feedstock, allowing accurate and precise control of the overall printing process. In other instances, a variety of metals may be used as feedstock, and the feedstock may be changed during the creation of a part so that the printed parts can be made from more than one metal.

An inert gas shielding and a feedstock electrode may be used as both an electrode and source of metal feedstock, an electric current that heats and melts the feed metal and base metal due to contact resistance. Such a combination can control the motion of the metal wire electrode and/or feedstock in three dimensions through a computer-controlled interface, allowing for deposition of material in the desired shape. These features can enable the production of 3D metal structures using any of a variety of metals and metal alloys with minimal safety concerns at low cost. In an aspect, the present disclosure provides a method of layer-by-layer fabrication of a three-dimensional metallic structure upon an electrically conductive base. A first layer of the structure may be formed by depositing a plurality of metal segments onto the base. Each metal segment can be deposited by (i) disposing a feedstock in contact with the base, and (ii) passing an electrical current through the feedstock and the base. A portion of the feedstock may melt to form the metal segment on the base. One or more subsequent layers of the structure may be formed by depositing pluralities of metal segments over the first layer of the structure. Each metal segment can be deposited by (i) disposing the feedstock in contact with a previously deposited metal segment, and (ii) passing an electrical current through the feedstock, the previously deposited metal segment, and the base. A portion of the feedstock can melt to form the metal segment on the previously deposited metal segment.

In some cases, gas may be flowed over at least a tip of the feedstock during deposition of the metal segments. The gas may reduce or substantially prevent oxidation of the metal segments during deposition. The gas may increase a cooling rate of the metal segments during deposition. After deposition of each metal segment, a relative position of the feedstock and the base may be changed with one or more mechanical actuators (e.g., stepper motors, solenoids, etc.). The feedstock may include, consist essentially of, or consist of any metal, or a plurality of metals, available in wire form. The feedstock may be selected from the group consisting of wire, ribbon, and sheet.

A porosity of at least a portion of the structure may be controlled by (i) altering a spacing between adjoining contact points between the feedstock and the base or underlying segments, and/or (ii) altering a magnitude of the current applied between the feedstock and the base and/or (iii) altering the amount of feedstock delivered to each portion of the structure. A computational representation of a three-dimensional structure may be stored. Sets of data corresponding to successive layers may be extracted from the computational representation, and each of the forming steps may be performed in accordance with the data. A size of at least one metal segment may be selected by controlling a speed of retraction of the feedstock therefrom (e.g., during and/or after deposition). An outer portion of the feedstock may be removed before the feedstock is melted to form at least one of the metal segments. An amount of feedstock utilized to form the first layer and the one or more subsequent layers of the structure may be tracked and/or stored. The metal segments can be formed in response to heat arising from, at least in part (e.g., substantially entirely due to), joule heating at the tip of the feedstock. For example, electrical current may flow through the tip of the feedstock into an underlying structure, such as the base or an underlying segment.

In another aspect, the present disclosure provides an apparatus for the layer-by-layer fabrication of a three-dimensional metallic structure from segments formed by melting a feedstock. The apparatus may comprise of an electrically conductive base for supporting the structure during fabrication, a feedstock-feeding mechanism for dispensing feedstock over the base, one or more mechanical actuators for controlling a relative position of the base and the feedstock-feeding mechanism, a power supply for applying a current that flows through the base in an amount sufficient to melt the tip of the feedstock, and circuitry for controlling the one or more actuators and the power supply to create the three-dimensional metallic structure on the base from successively released metal segments. Melting may result from heat arising from the current interacting with the electrical resistance of the feedstock tip, the contact between the feedstock and the object. The object may be the base.

The apparatus may include one or more of the following in any of a variety of combinations. The circuitry may include or consist essentially of a computer-based controller for controlling the one or more mechanical actuators and/or the power supply. The computer based controller may include or consist essentially of a computer memory and a 3D rendering module. The computer memory may store a computational representation of a three-dimensional structure. The 3D rendering module may extract sets of data corresponding to successive layers from the computational representation. The controller may cause the mechanical actuators and the power supply to form successive layers deposited metal segments in accordance with the data. The feedstock may be disposed within the feedstock-feeding mechanism.

The present disclosure also provides a method of layer-by-layer fabrication of a three-dimensional metallic structure upon an electrically conductive base. A sacrificial raft structure may be formed by depositing a plurality of metal segments onto the base. The sacrificial raft may be a separate part from the printed 3D object. The separate part may be a cylinder or plate. Each metal segment may be deposited by (i) disposing a first feedstock in contact with the base, and (ii) passing an electrical current through the first feedstock and the base. A portion of the first feedstock can melt to form the metal segment on the base. A first layer of the structure may be formed by depositing a plurality of metal segments onto the sacrificial raft structure. Each metal segment can be deposited by (i) disposing a first feedstock or second feedstock in contact with the sacrificial raft structure, and (ii) passing an electrical current through the first feedstock or second feedstock, the sacrificial raft structure, and the base. A portion of the first or second feedstock can melt to form the metal segment on the sacrificial raft structure. One or more subsequent layers of the structure may be formed by depositing pluralities of metal segments over the first layer of the structure. Each metal segment may be deposited by (i) disposing the first feedstock or second feedstock in contact with a previously deposited metal segment, and (ii) passing an electrical current through the first feedstock or second feedstock, the previously deposited metal segment, the sacrificial raft structure, and the base. A portion of the first feedstock or second feedstock may melt to form the metal segment on the previously deposited metal segment.

In some cases, the density and/or the porosity of the sacrificial raft structure may be less than that of the structure. The sacrificial raft structure may define one or more openings there through. The sacrificial raft structure may include, consist essentially of, or consist of a plurality of layers. A thickness of at least one of the layers of the sacrificial raft structure may be greater than a thickness of at least one of the layers of the structure. A thickness of at least one of the layers of the sacrificial raft structure may be greater than a thickness of all of the layers of the structure. A thickness of a bottom-most layer of the sacrificial raft structure (i.e., the layer of the sacrificial raft structure directly in contact with the base) may be greater than a thickness of at least one of, or even all of, the layers of the structure. After fabrication of the structure, the sacrificial raft structure may be removed from the base, and at least a portion of the structure may remain on the sacrificial raft structure. After the sacrificial raft structure is removed from the base, the sacrificial raft structure may be separated from the structure.

The first and second feedstocks may include, consist essentially of, or consist of different materials (e.g., different metals). The feedstock may comprise at least one type of material (e.g. metal). The first and second metal feedstocks may include, consist essentially of, or consist of the same material (e.g., the same metal). The metal segments may be formed in response to heat arising from, at least in part (e.g., substantially entirely due to), joule heating at the tip of the feedstock. The heat may result from current flowing through the tip of the feedstock and an underlying structure with which it is in direct contact. The underlying structure may be the base, the raft, or an underlying segment.

Another aspect of the present disclosure provides a non-transitory computer readable medium comprising machine executable code that, upon execution by one or more computer processors, implements any of the methods above or elsewhere herein.

Another aspect of the present disclosure provides a system comprising one or more computer processors and computer memory coupled thereto. The computer memory comprises machine executable code that, upon execution by the one or more computer processors, implements any of the methods above or elsewhere herein.

Additional aspects and advantages of the present disclosure will become readily apparent to those skilled in this art from the following detailed description, wherein only illustrative embodiments of the present disclosure are shown and described. As will be realized, the present disclosure is capable of other and different embodiments, and its several details are capable of modifications in various obvious respects, all without departing from the disclosure. Accordingly, the drawings and description are to be regarded as illustrative in nature, and not as restrictive.

### INCORPORATION BY REFERENCE

All publications, patents, and patent applications mentioned in this specification are herein incorporated by reference to the same extent as if each individual publication, patent, or patent application was specifically and individually indicated to be incorporated by reference. To the extent publications and patents or patent applications incorporated by reference contradict the disclosure contained in the specification, the specification is intended to supersede and/or take precedence over any such contradictory material.

### BRIEF DESCRIPTION OF THE DRAWINGS

The novel features of the invention are set forth with particularity in the appended claims. A better understanding of the features and advantages of the present invention will be obtained by reference to the following detailed description that sets forth illustrative embodiments, in which the principles of the invention are utilized, and the accompanying drawings (also “Figure” and “FIG.” herein), of which:

FIG. 1 is a schematic of an additive manufacturing apparatus in accordance with various embodiments of the present disclosure;

FIGS. 2A-2G are schematics of the deposition of metallic segments during the fabrication of a three-dimensional object in accordance with various embodiments of the present disclosure;

FIG. 3 is a schematic of a printed three-dimensional object having regions of different segment resolutions in accordance with various embodiments of the present disclosure;

FIG. 4A is a schematic of segments printed with low porosity in accordance with various embodiments of the present disclosure;

FIG. 4B is a schematic of segments printed with high porosity in accordance with various embodiments of the present disclosure;

FIGS. 5A-5C schematically depict deposition of a segment from a feedstock in accordance with various embodiments of the present disclosure;

FIGS. 5D-5F schematically depict segments of different sizes deposited via use of different feedstock-retraction rates in accordance with various embodiments of the present disclosure;

FIG. 6 is a schematic of a mechanical feedstock-tracking system in accordance with various embodiments of the present disclosure;

FIG. 7 is a schematic of an optical feedstock-tracking system in accordance with various embodiments of the present disclosure;

FIG. 8 is a schematic of an anti jamming mechanism in accordance with various embodiments of the present disclosure;

FIGS. 9A-9B are schematic plan views of sacrificial structures printed between the base and a printed part in accordance with various embodiments of the present disclosure;

FIG. 9C is a schematic cross-sectional view of a part printed on a sacrificial structure on a base in accordance with various embodiments of the present disclosure;

FIG. 10A is a schematic illustration of removal of a sacrificial structure and printed part from a base in accordance with various embodiments of the present disclosure;

FIG. 10B is a schematic illustration of removal of a sacrificial structure from a printed part in accordance with various embodiments of the present disclosure;

FIG. 11 shows an example of a computer system that is programmed or otherwise configured to implement methods provided herein;

FIG. 12 is a schematic illustration of using raw material to parallelize the metal additive deposition in accordance with various embodiments of the present disclosure;

FIG. 13 is a schematic illustration of a subsystem for deposition of nodes in the printing process in accordance with various embodiments of the present disclosure;

FIG. 14 is a schematic illustration of a cutting tool for the feedstock in accordance with various embodiments of the present disclosure;

FIG. 15 is a schematic illustration of a subsystem for cutting sheet spool into small sheets in accordance with various embodiments of the present disclosure;

FIG. 16 is a schematic illustration of a subsystem in which ribbons are cut from a sheet by a laser array in accordance with various embodiments of the present disclosure;

FIG. 17 is a schematic illustration of a parallel circuit design for control of current in accordance with various embodiments of the present disclosure; and

FIG. 18 is a schematic illustration of a subsystem for purging unused metal in accordance with various embodiments of the present disclosure.

### DETAILED DESCRIPTION

While various embodiments of the invention have been shown and described herein, it will be obvious to those skilled in the art that such embodiments are provided by way of example only. Numerous variations, changes, and substitutions may occur to those skilled in the art without departing from the invention. It should be understood that various alternatives to the embodiments of the invention described herein may be employed.

As used herein, the singular forms “a,” “an,” and “the” include plural references unless the context clearly dictates otherwise. Any reference to “or” herein is intended to encompass “and/or” unless otherwise stated.

The term “three-dimensional object” (also “3D object”), as used herein, generally refers to an object or part that is printed by 3D printing. The 3D object may be at least a portion of a larger 3D object or an entirety of the 3D object.

Whenever the term “at least,” “greater than,” or “greater than or equal to” precedes the first numerical value in a series of two or more numerical values, the term “at least,” “greater than” or “greater than or equal to” applies to each of the numerical values in that series of numerical values. For example, greater than or equal to 1, 2, or 3 is equivalent to greater than or equal to 1, greater than or equal to 2, or greater than or equal to 3.

Whenever the term “no more than,” “less than,” or “less than or equal to” precedes the first numerical value in a series of two or more numerical values, the term “no more than,” “less than,” or “less than or equal to” applies to each of the numerical values in that series of numerical values. For example, less than or equal to 3, 2, or 1 is equivalent to less than or equal to 3, less than or equal to 2, or less than or equal to 1.

Three-dimensional printing may comprise the sequential addition of a material layer or joining of material layers or parts of material layers to form a 3D part or structure, in a controlled manner (e.g., under automated control). Three-dimensional printing may comprise the removal of one or more material layers.

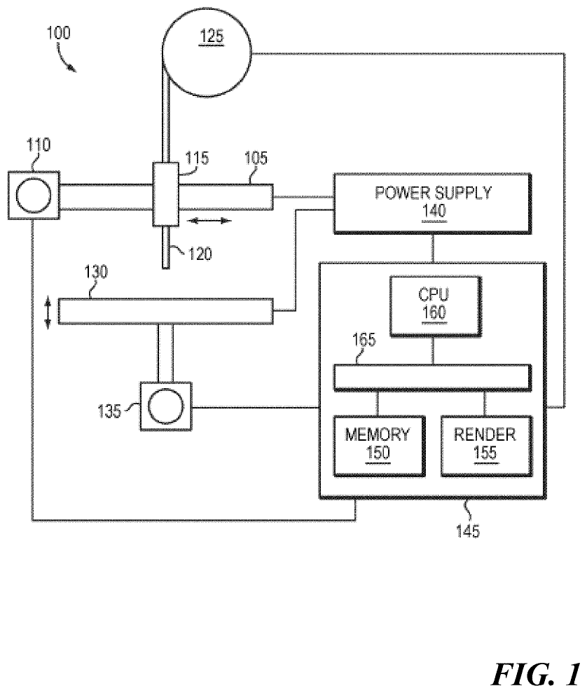

FIG. 1 shows an apparatus 100 (e.g., a deposition apparatus) that may be used to fabricate a 3D structure in a layer-by-layer manner. The apparatus 100 includes a mechanical gantry 105 capable of motion in one or more of five or six axes of control (e.g., one or more of the XYZ planes) via one or more actuators 110 (e.g., motors such as stepper motors). As shown, apparatus 100 also includes a feedstock feeder 115 that positions a feedstock 120 inside the apparatus, provides an electrical connection to the feedstock 120, and continuously feeds feedstock 120 from a source 125 (e.g., a spool) into the apparatus. The feedstock may be a metal wire, ribbon, or sheet. In some cases, the feedstock may be a particle or a plurality of particles (e.g., a powder). A base 130 may also be positioned inside the apparatus and provides an electrical connection; the vertical motion of the base 130 may be controlled via an actuator 135 (e.g., a motor such as a stepper motor). The base may be a base plate. The base may be a previously deposited at least a portion of the 3D part. An electric power supply 140 may connect to the feedstock 120 and the base 130, enabling electrical connection there between. The motion of the gantry 105 and the motion of the feedstock feeder 115 may be controlled by a computer-based control system (or “controller”) 145. The application of electric current and voltage from the power supply 140, as well as the power level and duration of the current and voltage, may be controlled by the controller 145. Electrical current may flow through the feedstock 120 upon contact between the feedstock 120 and the base 130 or another layer on or adjacent to the base 130. For instance, the power supply 140 may provide a voltage differential between the feedstock 120 and the base 130. Upon the feedstock 120 coming in contact with the base 130, electrical current may flow from the feedstock 120 to the base 130, or vice versa.

The feedstock may comprise one or more metals. The feedstock can be one or more metal wires. The feedstock may be selected from the group consisting of wire, ribbon, and sheet. In some cases, the feedstock may comprise different metals. The feedstock may comprise at least one type of metal. The feedstock may comprise one or more metals selected from the group consisting of steel, stainless steel, tool steel, iron copper, gold, silver, cobalt, chromium, nickel, titanium, platinum, palladium, titanium, and aluminum. The feedstock may comprise alloys, such as super alloys. A super alloy may be a combination of elements that provides enhanced material properties as compared to other alloys, such as durability, strength, melting, resistance to thermal deformation, stability, and/or resistance to oxidation. The super alloy may be selected from the group consisting of chromium cobalt, hastelloy, inconel, waspaloy, rene alloys, haynes alloys, incoloy, MP98T, TMS alloys, and CMSX single crystal alloys.

The feedstock may be pre-formed or pre-processed. Notches may be added into the feedstock by cutting or pressing vertically down and perpendicular to the surface. The methods of notching may comprise tube notching, end notching, or side notching.

In some cases, the feedstock may be cleaned, prior or during printing, using a cleaning component to remove impurities prior to feeding into the feedstock feeder. The cleaning component may comprise a heater for creating a heating profile around the feedstock to promote evaporation of the impurities. Specifically, the feedstock may enter into the cleaning component and the outer surface of the feedstock may be heated to evaporate residues and to deliver a feedstock with a clean surface. The cleaning component may be used to deoxidize the feedstock. The feedstock may be one or more wires.

The feedstock or base may be cleaned with a shielding gas to remove impurities and oxides. The shielding gas may prevent exposure of the feedstock or base surface to hydrogen, oxygen, and nitrogen found in the atmosphere. A shielding gas may be used to chemically reduce, oxidize, or otherwise remove impurities in the atmosphere, from the feedstock, and/or from the 3D object. For example, hydrogen (H₂) or another reducing agent may be used to react with oxygen to reduce or eliminate any metal oxides that may be present on the 3D object and/or feedstock. As another example, oxygen may be used to react with any carbon that may be present on the 3D object and/or feedstock. The shielding gas may be one or more members selected from the group consisting of hydrogen, nitrogen, argon, helium, carbon dioxide, and oxygen. In some cases, the shielding gas may be a mixture of an inert gas (e.g., argon or helium) with less than or equal to about 40%, 35%, 30%, 25%, 20%, 15%, 10%, 5%, 4%, 3%, 2%, 1%, or less of another gas, such as, for example, carbon dioxide (CO₂), carbon monoxide (CO), hydrogen (H₂) or oxygen (O₂), or a combination of such other gases (e.g., Ar with at most a 1% mixture of H₂ and CO₂). In some cases, the shielding gas may be a mixture of an inert gas (e.g., argon or helium) with at least about 1%, 2%, 3%, 4%, 5%, 10%, 15%, 20%, 25%, 30%, 35%, 40%, 50%, or more of another gas, such as, for example, carbon dioxide (CO₂), carbon monoxide (CO), hydrogen (H₂) or oxygen (O₂), or a combination of such other gases (e.g., Ar with at least a 1% mixture of H₂ and CO₂).

The controller 145 in accordance with embodiments of the present disclosure may include, for example, a computer memory 150 and a 3D rendering module 155. Computational representations of 3D structures may be stored in the computer memory 150, and the 3D rendering module 155 may extract sets of data corresponding to successive layers of a 3D structure from a computational representation (e.g., model design of the 3D structure). The controller 145 may control the mechanical actuators 110, 135, feedstock-feeding mechanism 115, and power supply 140 to form successive layers deposited metal segments in accordance with the data.

The controller 145 in accordance with methods and systems of the present disclosure may include or consist essentially of a general-purpose computing device in the form of a computer including a processing unit (or “computer processor”) 160, the system memory 150, and a system bus 165 that couples various system components including the system memory 150 to the processing unit 160. Computers typically include a variety of computer-readable media that can form part of the system memory 150 and be read by the processing unit 160. By way of example, and not limitation, computer readable media may include computer storage media and/or communication media. The system memory 150 may include computer storage media in the form of volatile and/or nonvolatile memory such as read only memory (ROM) and random access memory (RAM). A basic input/output system (BIOS), containing the basic routines that help to transfer information between elements, such as during start-up, may be stored in ROM. RAM may contain data and/or program modules that are immediately accessible to and/or presently being operated on by processing unit 160. The data or program modules may include an operating system, application programs, other program modules, and program data. The operating system may be or include a variety of operating systems such as Microsoft WINDOWS operating system, the Unix operating system, the Linux operating system, the Xenix operating system, the IBM AIX operating system, the Hewlett Packard UX operating system, the Novell NETWARE operating system, the Sun Microsystems SOLARIS operating system, the OS/2 operating system, the BeOS operating system, the MACINTOSH operating system, the APACHE operating system, an OPENSTEP operating system or another operating system of platform.

Any suitable programming language may be used to implement without undue experimentation the functions described herein. Illustratively, the programming language used may include assembly language, Ada, APL, Basic, C, C++, C*, COBOL, dBase, Forth, FORTRAN, Java, Modula-2, Pascal, Prolog, Python, REXX, and/or JavaScript for example. Further, it is not necessary that a single type of instruction or programming language be utilized in conjunction with the operation of systems and techniques of the present disclosure. Rather, any number of different programming languages may be utilized as is desirable.

The computing environment may also include other removable/nonremovable, volatile/nonvolatile computer storage media. For example, a hard disk drive may read or write to nonremovable, nonvolatile magnetic media. A magnetic disk drive may read from or writes to a removable, nonvolatile magnetic disk, and an optical disk drive may read from or write to a removable, nonvolatile optical disk such as a CD-ROM or other optical media. Other removable/nonremovable, volatile/nonvolatile computer storage media that can be used in the operating environment include, but are not limited to, magnetic tape cassettes, flash memory cards, digital versatile disks, digital video tape, solid state RAM, solid state ROM, and the like. The storage media may be connected to the system bus through a removable or non-removable memory interface.

The processing unit 160 that executes commands and instructions may be a general-purpose computer processor, but may utilize any of a wide variety of other technologies including special-purpose hardware, a microcomputer, mini-computer, mainframe computer, programmed micro-processor, micro-controller, peripheral integrated circuit element, a CSIC (Customer Specific Integrated Circuit), ASIC (Application Specific Integrated Circuit), a logic circuit, a digital signal processor, a programmable logic device such as an FPGA (Field Programmable Gate Array), PLD (Programmable Logic Device), PLA (Programmable Logic Array), RFID processor, smart chip, or any other device or arrangement of devices that is capable of implementing the steps of the processes of embodiments of the present disclosure.

In an aspect, the present disclosure provides a system for depositing (e.g., printing) at least a portion of a 3D object in a layer by layer addition of at least one feedstock. The system may be configured to form the at least a portion of the 3D object by subjecting at least one feedstock to heating upon flow of electrical current through the at least one feedstock and into the base. The heating may be resistive heating (e.g. Joule heating). The system can be configured to form the at least a portion of the 3D object by subjecting at least one feedstock to heating upon flow of electrical current through the base and into the at least one feedstock.

The system may comprise a base for supporting the at least a portion of the 3D object during deposition. The base may be an electrically conductive base. The base may be a base plate. The base may be a previously deposited at least a portion of the 3D object. The base may be a rotating base plate, such as a cylinder or a turntable. In other instances, the base may be a support material. The support material may be removable. The base may rotate or move along the x, y, and z axis while printing at least a portion of the 3D object. The base may be controlled by one or more of an x-axis motor, y-axis motor, or z-axis motor to move the base in the x, y, and z positions.

The base may comprise one or more sensors and/or heating elements. The sensor may be located external to the base. The base may comprise holes for sensors and heating elements. The heating element may be a heating cartridge. The one or more sensors may be selected from the group consisting of thermocouple, pyrometer, radiation thermometer, thermal imager, infrared thermometer, line scanner, fiber optic temperature sensor, camera, infrared sensors, photo detector, optical pyrometer, optical emission spectrometer, thermistor, frequency response analyzer, magnetometer, gas flow sensor, accelerator, contact force sensor, weight measure, position sensor, electrical energy sensor, electrical resistance sensor, inductance sensor, and capacitance sensor. In some cases, the base may comprise a material with high ductility and low yield strength when compared with the material of the at least a portion of the 3D object. In some cases, the base may comprise a material of low elastic modulus and high strain to failure as compared with the material of the at least a portion of the 3D object. The base may include a material that can fuse with the material of the at least a portion of the 3D object. In some cases, the at least a portion of the 3D object may be grounded and secured onto a build plate using devices, such as clamps or probes.

The base may be re-useable for building successive part(s) by the deposition process. In some instances, the base may be or may comprise a top layer that may be removed after each build to redefine the base. In some cases, the thickness and/or construction of the upper portion of the base may be arranged to permit at least about 1, 2, 3, 4, 5, 10, 15, 20, or more builds. In some cases, the thickness and/or construction of the upper portion of the base may be arranged to permit less than or equal to about 30, 20, 15, 10, 5, 4, 3, 2, or 1 build. In some cases, a thickness of less than or equal to about 100 millimeters (mm), 50 mm, 25 mm, 20 mm, 15 mm, 10 mm, 9 mm, 8 mm, 7 mm, 6 mm, 5 mm, 4 mm, 3 mm, 2 mm, 1 mm, or less may be milled, or otherwise removed, from the top of the base to redefine the build surface after each build. In some cases, a thickness of at least about 1 mm, 2 mm, 3 mm, 4 mm, 5 mm, 6 mm, 7 mm, 8 mm, 9 mm, 10 mm, 15 mm, 20 mm, 25 mm, 50 mm, 100 mm, or more may be milled, or otherwise removed, from the top of the base to redefine the build surface after each build.

By removing the build material from the base, any material that may have plastically deformed during the previous build may be removed. This process may leave material that has elastically deformed on the base. As such, the material properties or mechanical properties in the base surface may therefore be restored.

In some cases, the base may be a support. The support may comprise a different material than the at least a portion of the 3D object. In some cases, the support may comprise the same material as the at least a portion of the 3D object. The support may comprise a boiling point higher than the print temperature. In this instance, the support may not vaporize at the print temperature. In some cases, the support may comprise a favorable melting point to electrical conductivity ratio and may be more electrically and thermally conductive. The support material may also comprise limited solubility in the print metal and may not embrittle the print feedstock to induce undesired properties, such as warping. The support material may comprise one or more crystal structures selected from the group consisting of body centre cubic (BCC), face centred cubic (FCC), and hexagonal closest packing (HCP). For example, a metal, such as magnesium, may be used as a support material as it demonstrates desirable electrical and thermal properties, low solubility in the print materials, and ease of removal. Table 1 illustrates examples of various print materials and support materials and their properties.

TABLE 1
Illustrative examples of print materials and potential support materials.

| Print | Melting | Crystal | Support | Support |
|---|---|---|---|---|
| Material | Temperature | Structure | Material | Removal |
| ER70S-6 | 1427° C. | BCC (FCC | Mo (BCC), | Electrochemical, |
| | | at 910° C.) | Mg (HCP) | Dissolve, Melt- |
| | | | | away |
| SS 308 | 1450° C. | FCC | Mo (BCC), | Electrochemical, |
| | | | Mg (HCP) | Dissolve, Melt- |
| | | | | away |
| T1-6Al-4V | 1640° C. | HCP | Co (HCP), | Electrochemical, |
| | | | Fe (BCC), | Dissolve, Melt- |
| | | | Mg (HCP) | away |
| AA 6061 | 630° C. | FCC | Mo (BCC), | Electrochemical, |
| | | | Co (HCP), | Dissolve |
| | | | Mg (HCP) | |
| Cu (99.9+) | 1085° C. | FCC | Co (HCP), | Electrochemical, |
| | | | Mg (HCP) | Dissolve, Melt- |
| | | | | away |

In some cases, the at least a portion of the 3D object may be removed from the base by one or more methods selected from the group consisting of melting, dissolution, electrolysis, electrochemical removal, mechanical removal, or non-mechanical removal. For example, if an intermetallic layer forms between the print material and the base, mechanical removal may be used to break off the brittle intermetallic layer. In some cases, the at least a portion of the 3D object may comprise a portion that is suitable for mechanical removal. In some cases, upon cooling to the right temperature, the at least a portion of the 3D object may be removed without mechanically or chemically removing material from the at least a portion of the 3D object.

In some cases, the system may comprise at least one sheet that is secured to the base, and to which the 3D object is secured during printing. The sheet may comprise a material that adheres to the at least one feedstock material. The sheet may become part of the 3D object. For example, the system may print fins on top of a base of a heat sink. The sheet may take the form of the base. In some cases, the sheet may comprise one or more members selected from the group consisting of metallic mesh, foil, and film. In the case that the sheet is a mesh, the mesh may comprise a series of wires. The wires may be tubular wires that are woven together such that the wires can slide individually over one another. The sheet may be a malleable or deformable material to allow the finished component to be easily removed from the base. The method of removal may be peeling or tearing. In some cases, the sheet can be less than or equal to about 10,000 micrometers (microns), 5000 microns, 1000 microns, 750 microns, 500 microns, 250 microns, 200 microns, 150 microns, 100 microns, 50 microns, or less in thickness. In some cases, the sheet can be at least about 25 microns. In some cases, the at least one sheet may be magnetically secured to the base. In some cases, the at least one sheet may be non-magnetically secured to the base. For example, the sheet may be secured using legs, rails, springs, a quick latch and release mechanism, or a vacuum.

The sheet may be secured to the base by the application of vacuum pressure. For example, the base may comprise channels or holes in which a vacuum can be applied. The sheet may require a thickness and flatness appropriate for holding the vacuum. The vacuum pressure may be lowered with respect to the atmosphere within the build chamber of the system. In this circumstance, the sheet connected to the base may be held in place by the pressure differential. Using a vacuum for securing the sheet onto the base may be advantageous in that the vacuum pressure can be applied and removed at various speeds resulting in instantaneous and efficient exchange of the sheet. The vacuum may be varied to alter flow of heat or the flow of the electrical current. The at least one sheet may be removably secured to the electrically conductive base.

The system may further comprise at least one deposition head connected to at least one multi-axis robotic arm for dispensing the at least one feedstock. The print head may not be in contact with the base. The multi-axis robotic arm may enable the print head to operate and deposit feedstock in one or more planes and/or orientations. The multi-axis robotic arm may be a six-axis or seven axis robotic arm for dispensing the at least one feedstock. The six axes of manipulation may result in non-planar material deposition paths, and allow for fabrication without the use of a base or support material. The print head may add material from one or more directions (e.g., the x-axis, y-axis, z-axis). Three degrees of freedom (or three axes) X-Y-Z may be employed, in which the 3D object may be built one layer at a time. Additionally, the object may be rotated around the x-axis, the y-axis, or the z-axis during printing. In some instances, the print head may deposit a segment at any point on the surface of the at least a portion of the 3D object from any direction.

In some cases, the 3D printer may comprise one or more sensors for measuring at least one property of the 3D object. The one or more sensors may be external to the base. The sensor may be in the base. The one or more sensors may be selected from the group consisting of camera, infrared sensors, photo detector, optical pyrometer, optical emission spectrometer, thermocouple, thermistor, frequency response analyzer, magnetometer, gas flow sensor, accelerator, contact force sensor, position sensor, electrical energy sensor, electrical resistance sensor, inductance sensor, capacitance sensor, and weight measure. The frequency response analyzer can be used to measure impedance. The magnetometer can be used to measure the magnetic fields. The accelerator can be used to measure vibration. The one or more sensors may be used in process and off process.

In another aspect, the present disclosure provides a method for depositing (e.g., printing) a 3D object adjacent to a base. In computer memory, a computational representation of the 3D object may be received. A deposition head (e.g., a print head) may be used to initiate deposition of the 3D object by, (i) directing at least one feedstock through a feeder towards the base and (ii) flowing the electrical current through the at least one feedstock and into the base. Next, the at least one feedstock may be subjected to heating upon flow of electrical current through the at least one feedstock and into the base. The heating may be sufficient to melt at least a portion of the at least one feedstock. The heating may be resistive heating (e.g. Joule heating). In some cases, the method for depositing a 3D object using Joule heating may be called Joule printing. In some cases, the at least one layer may be deposited adjacent to the base in accordance with the computational representation of the 3D object, thereby depositing the 3D object. In some cases, the at least one layer of the at least a portion of the at least one feedstock may be shaped using one or more tips. The shaping may comprise mechanical manipulation. The shaping may comprise removing material, such as cutting. The processes of depositing and shaping may be repeated one or more times to deposit and shape additional portion(s) of the at least one feedstock adjacent to the base. Subsequent to shaping, a relative position of the one or more tips may be changed with respect to the at least one layer. In some cases, the shaping may be performed after printing of the 3D object. The shaping may occur by variation of one or more parameters selected from the group consisting of pressure, heat, power, and air quantity. In some cases, the step of deposition may comprise cutting of the feedstock during or after deposition of the at least one layer. The base may be a preexisting 3D object requiring repair, a prior layer of a newly printed part, or an electrically conductive build plate.

In some cases, the one or more tips may be coupled to the deposition head (e.g., at the same time or different times) for shaping at least one layer of the 3D object. The one or more tips may be coupled external to the print head. In some cases, one or more tips can be attached to the print head at any one time. Furthermore, such tips can be disposable (e.g., disposed automatically or manually). The one or more tips may be interchangeable deposition tips. Such tips may be selectively used to deposit at least a portion of the 3D object onto the build surface in various shapes or sizes to form the 3D object according to a predetermined order and pattern. In some cases, the one or more tips can be, mechanically, electronically, manually or magnetically adjusted to a different size or shape. Examples of the one or more tips may include, but not limited to, a reshaping lip, pressing tip, ironing tip, and/or ironing plate. The tips may compress the at least one feedstock material along the base. The one or more tips may press at least a portion of the 3D object exiting from the print head. Such tips may compress a previously deposited one or more layers. The one or more tip may be used to re-shape the feedstock after or during printing. Mechanical manipulation of the feedstock material (e.g., molten feedstock material) may be accomplished by varying pressure, heat and power, and forced gas on the at least a portion of the 3D object.

In some cases, the one or more tips may be a smearing tip or a re-melting tip. The tip may be a trailing head that smears the at least a portion of the 3D object while it is hot. In some cases, the 3D object can be concurrently printed and smoothed or printed followed by smoothing. A cutter may be used, prior to, during, and/or after shaping, for cutting a portion of the at least one feedstock during or after deposition.

In some cases, the shaping process may comprise mechanical manipulation. The shaping step may comprise machining of the at least one layer of the at least the portion of the at least one feedstock. The machining may comprise one or more processes selected from the group consisting of grinding, polishing, lapping, honing, electrical discharge machining, lithography, industrial etching, computer numerical control machining, mill finishing, abrasive blasting, laser texturing, and polishing. The deposition and the machining of the 3D object may be completed in the same apparatus. In some cases, the finished 3D object may comprise a predetermined lay. The lay may be the direction of the predominant surface pattern, which is determined by the machining process. The lay may be vertical, horizontal, radial, cross-hatched, circular, isotropic, or a combination thereof.

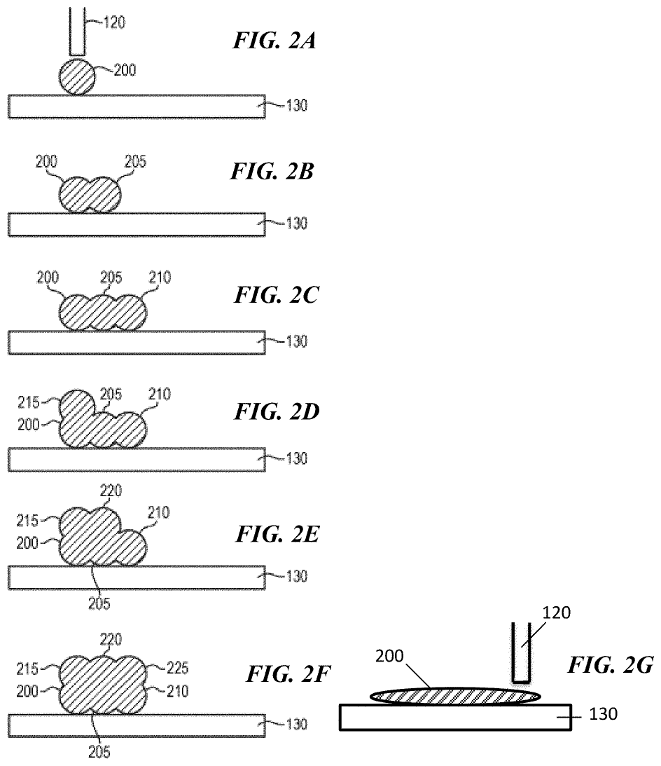

Embodiments of the present disclosure form metal structures via metal segments formed at the molten tip of a feedstock, as shown in FIGS. 2A-2F. As shown, the formation of the 3D structure typically begins with the deposition of a single segment 200 melted from the feedstock 120 onto the base 130. The segment 200 and subsequent segments may have any morphology. In some instances, the segment may be substantially spherical. Additional segments 205, 210 are deposited one by one adjacent to previously deposited segments, and the heat from the formation of each new segment partially melts the adjacent segments and fuses them together. Once all of the segments that are adjacent to one another on a single layer for the structure have been deposited, deposition of segments 215, 220, 225 begins one by one on top of the previous layer of fused segments 200, 205, 210. Deposition continues in this manner, layer by layer, until the entire structure is completed. In some instances, the deposited segment may be a linear segment as illustrated in FIG. 2G rather a voxel. Each layer of the structure may comprise a different number of segments, depending on the shape of the structure, and segments in an overlying layer may not need to be (but may be, in various embodiments) deposited directly on top of a segment of an underlying layer. In some cases, the feedstock may be insulated or conducted onto the base according to various patterns.

The diameter of the segments may determine the height of each layer, and as such may at least in part dictate the resolution at which structures may be formed. The height of the layers can impact the resolution of the process. The vertical resolution, e.g. layer thickness or layer height, may be the minimal thickness of a segment that the printer produces in one pass. A smaller segment thickness can result in a smoother printed surface. In some cases, the resolution may be a factor of the segment diameter and/or the precision of the print head movements on the X and Y axis. The horizontal resolution, e.g. XY resolution, may be the smallest movement the deposition head can make within a layer on the X and the Y axis. A smaller movement can result in finer details deposited.

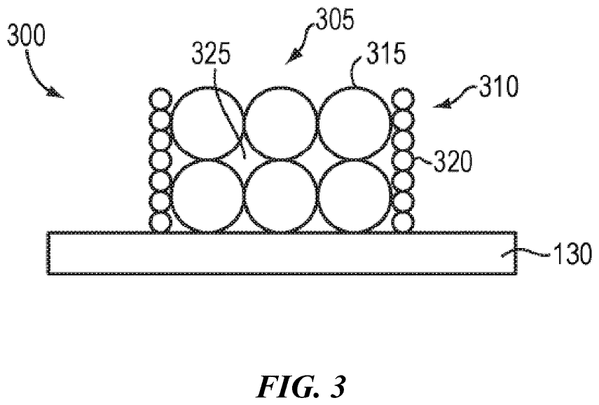

The diameter of the segments may be changed by changing the diameter of the feedstock 120, as well as the deposition parameters (e.g., current level), and thus the resolution of the structure may be controlled dynamically during the process. In some cases, higher resolution may increase the time required to form the structure, and lower resolution can decrease the time. Therefore, sections of 3D objects may be fabricated with high resolution to hold a tight mechanical tolerance or to be more visually appealing, and others sections may be fabricated at low resolution to increase the speed of deposition, as shown in FIG. 3. FIG. 3 depicts a printed structure 300 composed of a low-resolution portion 305 at least partially surrounded by a high-resolution portion 310. As shown, the low-resolution portion 305 includes or consists essentially of multiple larger segments 315, while high-resolution portion 310 includes or consists essentially of multiple smaller segments 320. The portions 305, 310 may include pores 325 between segments that result from empty space remaining between segments during melting thereof.

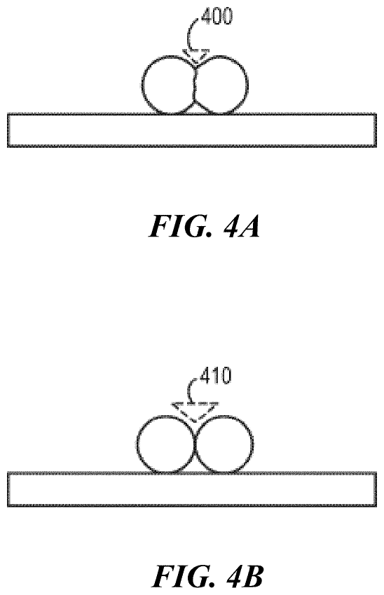

The porosity of the fabricated 3D structure may be determined, at least in part, by the spacing and/or extent of fusion between adjacent segments, as shown in FIGS. 4A and 4B. FIG. 4A depicts two segments fused closely together, resulting in a smaller porosity signified by smaller porous region 400 (which may, in a completed part, be at least a portion of a pore there within), and FIG. 4B depicts two segments fused together to a lesser extent, resulting in higher porosity signified by a larger porous region 410. Deposition parameters may be varied to determine the degree of fusion between segments, mainly through the amount of heat generated during deposition. If heat is increased, fusion between segments will be greater, and porosity will generally be lower. If enough heat is generated, the resulting structure may have substantially no porosity, which may be appropriate to achieve specific mechanical properties. Conversely, less heat may cause less fusion, and porosity can be higher. A more porous structure may typically have a lower weight than a fully dense structure. Since the amount of heat may be controlled dynamically during deposition, sections of the 3D structure may be made more porous than other sections. For example, a porous filter may be contained in an internal passage of a larger 3D object. The application of less heat may require less time, so the speed of deposition may be increased if porosity is appropriate or may be tolerated in sections of the structure. Materials with high porosity typically may have low tensile strength but may achieve good compressive strength. Structures may be designed so that areas in compressive loading may be produced with some porosity, leading to faster deposition speed, and also lower weight of the finished structure. The porosity may also be controlled by controlling the amount of mass added to the melt pool.

In accordance with the methods and systems of the present disclosure, metal segments are formed by melting the tip of the feedstock 120 with electric current. The feedstock 120 may have a substantially circular, rectangular, square, ovular cross-section, or a partial shape or a combination of shapes thereof. The diameter (or other lateral cross-sectional dimension) of the feedstock 120 may be chosen based on the properties of deposition, but generally may be between about 0.001 mm and 1000 mm, or 0.01 mm and 100 mm, or 0.1 mm and 10 mm, or 0.1 mm and 1 mm. The diameter (or other lateral cross-sectional dimensional) may be at least about 0.001 mm, 0.01 mm, 0.1 mm, 1 mm, 10 mm, 100 mm, 1000 mm, or more. In some cases, the diameter (or other lateral cross-sectional dimensional) may be less than or equal to about 1000 mm, 100 mm, 10 mm, 1 mm, 0.1 mm, 0.01 mm, 0.001 mm, or less. The feedstock 120 may be one electrode, and the metallic base 130 of the apparatus 100 may be the other electrode, as shown in FIG. 1. When the feedstock 120 is in physical contact with the base 130, the two are also in electrical contact. Electrical resistance between the feedstock 120 and base 130 may occur due to the small surface area of the fine feedstock 120 and the microscopic imperfections on the surface of the base 130 and the tip of the feedstock 120. The resistance between the feedstock 120 and base 130 is the electrical resistance experienced by an electric current that is passed between the two electrodes (i.e., the feedstock 120 and base 130), and the local area at the contact point is heated according to Equation 1 (i.e., Joule's First Law).

Q=I²×R×t Equation 1

The heat generated (Q) is in excess of the heat required to melt the tip of the feedstock 120 into a segment and to fuse the segment to adjacent segment. The heat may be determined by the amount of current passed (I), the resistance between the feedstock 120 and base 130 (R), and the duration of the application of current (t). (Thus, methods and systems of the present disclosure can form segments without use or generation of electrical arcs and/or plasma, but rather utilize resistance-based melting of the feedstock.) Current and time (I and t) may be controlled during the process via controller 145 and power supply 140. In some cases, a high current is utilized for a short duration (as opposed to a lower current for a longer duration) to increase the speed of deposition. The current and duration depends on the deposition properties, but these may generally range from approximately 10 Amperes (A) to approximately 2000 A and approximately 0.01 seconds (s) to approximately 1 s. In some cases, the current may be at least about 1 A, 2 A, 3 A, 4 A, 5 A, 6 A, 7 A, 8 A, 9 A, 10 A, 20 A, 30 A, 40 A, 50 A, 60 A, 70 A, 80 A, 90 A, 100 A, 200 A, 300 A, 400 A, 500 A, 600 A, 700 A, 800 A, 900 A, 1000 A, 1100 A, 1200 A, 1300 A, 1400 A, 1500 A, 1600 A, 1700 A, 1800 A, 1900 A, 2000 A, or more. In some cases, the current may be less than or equal to about 2500 A, 2000 A, 1900 A, 1800 A, 1700 A, 1600 A, 1500 A, 1400 A, 1300 A, 1200 A, 1100 A, 1000 A, 900 A, 800 A, 700 A, 600 A, 500 A, 400 A, 300 A, 200 A, 100 A, 90 A, 80 A, 70 A, 60 A, 50 A, 40 A, 30 A, 20 A, 10 A, 9 A, 8 A, 7 A, 6 A, 5 A, 4 A, 3 A, 2 A, or less. In some cases, the duration may be at least about 0.01 s, 0.02 s, 0.03 s, 0.04 s, 0.05 s, 0.06 s, 0.07 s, 0.08 s, 0.09 s, 0.1 s, 0.2 s, 0.3 s, 0.4 s, 0.5 s, 0.6 s, 0.7 s, 0.8 s, 0.9 s, 1 s, or more. In some cases, the duration may be less than or equal to about 5 s, 4 s, 3 s, 2 s, 1 s, 0.9 s, 0.8 s, 0.7 s, 0.6 s, 0.5 s, 0.4 s, 0.3 s, 0.2 s, 0.1 s, 0.09 s, 0.08 s, 0.07 s, 0.06 s, 0.05 s, 0.04 s, 0.03 s, 0.02 s, 0.01 s, or less. In some cases, the required current may be continuous. After the first layer of fused segments is completed, the previous layer of segments, which are in electrical contact with the base 130, may act as the second electrode. As the process proceeds, one electrode (the feedstock 120) may be consumed as metal from the tip of the feedstock 120 is utilized to form the segment.

The consumable feedstock may be used as an electrode. The feedstock may be stored on large spools and feed continuously to continue a deposition process. Thus, there may be many metal and metal alloy feedstocks that are readily available at low cost. In order to protect the deposited metal from oxidation, an inert gas (such as Ar) or semi-inert gas (such as N₂ or CO₂) may be flown over the area around the feedstock electrode to displace oxygen. For example, gas may be flown continuously at a certain rate (e.g., approximately 0.7 m³/hr during the deposition process) when the metal is at high temperature or is molten. Advantageously, gas flow rates may be increased beyond what is required to provide a shielding effect to increase the rate at which deposited metal cools. Cooling rate may also affect the resulting mechanical properties of the metal, and with dynamic control during deposition, sections of the structure may be fabricated with different mechanical properties. For example, a high cooling rate may be used on the surface of a structure to increase hardness and wear resistance, while a slower cooling rate may be used on the interior to maintain ductility and strength. Gas may also be pre-heated to a high temperature to further slow the cooling rate of the structure for improvements to ductility and strength.

In some cases, the material for the base electrode 130 is selected for good electrical conductivity and compatibility with the metal that is being deposited. The base 130 is typically non-consumable and thus is not damaged and may not need to be replaced during normal operation. The base material may be chosen to allow weak adhesion of the deposited metal to it, so that the first layer of deposited metal will hold the structure firmly in place on the base 130 during further deposition. For example, if the deposited metal is steel, copper, titanium, or aluminum may be appropriate materials for the base 130. Copper and aluminum may have a high electrical conductivity, may not alloy with steel and change the composition of the deposited metal, and may have good thermal conductivity so heat generated at the deposition area may be quickly conducted away, and there is no danger of melting the base 130. In some cases, the surface finish of the base 130 may be slightly rough, so that the metal of the first layer melts into the fine surface features (e.g., scratches) of the base 130 and allows for weak adhesion. The surface finish of the base 130 may be chosen to give the appropriate amount of adhesion so the structure is held firmly during deposition, but that a reasonable force may be used to remove the finished structure from the base 130 at the end of deposition. The base 130 may be made easily replaceable so that it may be changed to an appropriate material for the deposition metal.

The morphology of the deposited segments may be controlled through the diameter of the feedstock 120, as well as the deposition parameters. The diameter of the deposited segment may typically be roughly the same diameter as the feedstock 120. The diameter of the segment may be increased by feeding additional feedstock 120 into the segment while it is still molten. The shape of the top of the segment may be influenced by the insertion or retraction of the feedstock 120 while the segment is still molten, for example, where the top of the segment may be drawn into a peak via feedstock retraction. If the segment is allowed to partially cool, the feedstock 120 may be used to push the top of the segment to flatten the segment. These manipulations of the segment morphology may be used to change the porosity of the structure.

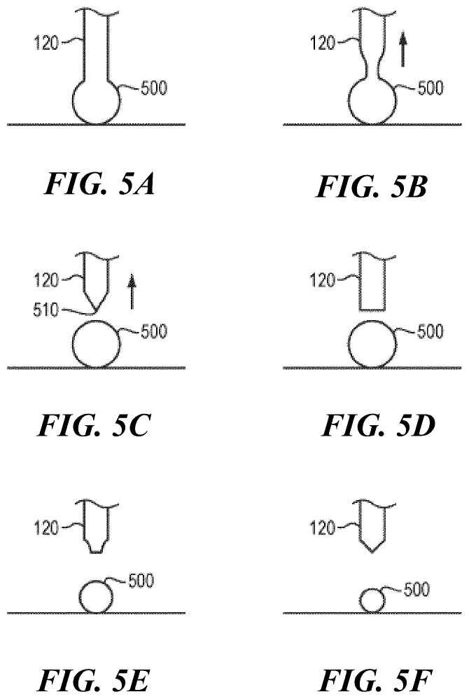

Similarly, insertion or retraction of the still molten feedstock tip from the previously deposited segment may be used to control the morphology of the tip of the feedstock 120, as illustrated in FIGS. 5A-5C. In various embodiments of the present disclosure, if the feedstock 120 is retracted quickly, the tip will be drawn into a sharp point. FIG. 5A depicts the initial formation of a segment 500 melting from the tip of feedstock 120. In FIG. 5B, the feedstock 120 is retracted from the segment 500, which is still at least partially molten. As shown, the tip of the feedstock 120 begins to neck down, decreasing its diameter. FIG. 5C illustrates the sharp tip 510 of the feedstock 120 after full retraction and separation from the segment 500. The speed to retraction or insertion may thus be used to control the diameter of the tip of the feedstock 120. Since the diameter at the tip is the effective diameter of the feedstock 120 for the next deposition, this controlled necking may be used to deposit segments with a diameter smaller than the bulk feedstock diameter. In this manner, higher resolution deposition is possible with larger feedstock diameters. FIGS. 5D-5F illustrate different sized segments 500 that may be deposited using the same feedstock via control of the retraction or insertion speed of the feedstock when depositing the previous segments. Necking of the feedstock can also be controlled by limiting the amount of feedstock feed per unit of travel. For example, moving faster in in the X-Y plane without increasing feedstock feed rate can produce a smaller diameter deposit.

In another aspect, the present disclosure provides a method for depositing (e.g., printing) a 3D object adjacent to a base. At least one deposition parameter may be calculated based at least in part on a computational representation of the 3D object. At least a portion of the 3D object may be printed by subjecting at least one feedstock to resistive heating (e.g., Joule heating) upon flow of electrical current through at least one feedstock and into the base. A deposition head and the at least one deposition parameter may be used to initiate deposition of the 3D object by subjecting at least one feedstock to heating upon flow of electrical current through the at least one feedstock and into the base, or vice versa. The heating may be sufficient to melt at least a portion of the at least one feedstock. The heating may be resistive heating (e.g. joule heating). While printing the 3D object with the deposition head, one or more properties of the 3D object or the at least one feedstock may be measured. Additionally, it may be determined whether the one or more properties of the 3D object measured meet the one or more predetermined properties of the 3D object or the at least one feedstock.

The mass or energy of the 3D object or at least one feedstock may be computed. The mass or energy of the 3D object or at least one feedstock may be stored in computer memory. The at least one deposition parameter may be adjusted upon determining that the one or more properties of the 3D object or the at least one feedstock measured, while printing the 3D object, do not meet the one or more predetermined properties, to yield at least one adjusted deposition parameter. In some cases, the deposition head and the at least one adjusted deposition parameter may be used to continue to print the 3D object.

In some cases, the one or more predetermined properties may be generated by simulating the 3D object. The simulating may include finite element analysis. The simulating may be performed prior to depositing the 3D object. The at least one deposition parameter may be adjusted in real time while the 3D object is being deposited. In some cases, the printing may stop, then the at least one deposition parameter may be adjusted, and the printing may commence. The at least one feedstock may be a metal wire or a multi-metal wire. The multi-metal wire may be a tubular multi-metal wire. For example, the feedstock may comprise one metal that hold, another metal in a tubular geometry. The at least one deposition parameter may be energy or mass of the 3D object or the at least one feedstock. The at least one deposition parameter may correspond to an energy or mass of at least one voxel of the 3D object or the at least one feedstock.

Adjusting the at least one deposition parameter may comprise controlling a mass of the 3D object or the at least one feedstock. In some cases, adjusting the at least one deposition parameter may comprise controlling a deposition rate or mass flow rate during the printing of the 3D object.

The at least one deposition parameter may be a tool path trajectory or a process parameter usable by the deposition head for depositing the 3D object. The measuring one or more properties of the 3D object or the at least one feedstock may comprise measuring at least one deposition parameter of the base or environment in which the 3D object is being generated. Such measuring may further comprise using one or more sensors to measure one or more properties of the 3D object. The one or more sensors may be selected from the group consisting of camera, infrared sensors, photo detector, optical pyrometer, optical emission spectrometer, thermocouple, thermistors, frequency response analyzer, magnetometer, gas flow sensor, accelerator, contact force sensor, position sensor, electrical energy sensor, electrical resistance sensor, inductance sensor, capacitance sensor, and weight measure. The frequency response analyzer may be used to measure impedance. The magnetometer can be used to measure the magnetic fields. The accelerator can be used to measure vibration.

The methods of measuring at least one deposition parameter may comprise using one or more members selected from the group consisting of optical pyrometry, infrared thermography, spectroscopy, laser ultrasonic, contact force measurement, position measurement, electrical energy measurement, electrical resistance measurement, inductance measurement, capacitance measurement, and weight measurement. The one or more properties of the 3D object may comprise one or more members selected from the group consisting of modulation signal, mass, thermal mass, mass flow rate of the at least one feedstock, chamber temperature, heat capacity, surface temperature, current, voltage, contact force of the tip of the least one feedstock, and amount of the at least one feedstock. Such measurements may be used for statistical process control of the 3D printing process. In some cases, the measurements may be used for non-destructive assessment of the 3D printed object. The modulation signal may be pulse width modulation. The at least one deposition parameter may comprise one or more members selected from the group consisting of resistance of the at least one feedstock or at least a portion of the 3D object, contact force of the at least one feedstock, geometry of the at least one feedstock, geometry of the at least a portion of the 3D object, position of the at least one feedstock, position of the at least a portion of the 3D object, position of the print head and the base, position of the deposition head and a previous layer, amount of the feedstock used during the printing, electrical energy output of the printing, current, voltage applied between the at least one feedstock and the base, electrical resistance parameter, inductance of the at least one feedstock or at least a portion of the 3D object, and capacitance of the at least one feedstock or at least a portion of the 3D object. In some cases, the process parameter may be adjusted after deposition of the first layer or a voxel located at the edge of the at least a portion of the 3D object.

In some cases, the deposition apparatus may comprise a feedback circuit. The feedback circuit may be coupled to the output of a power supply to generate a feedback signal, which is representative of an output level of the power supply. Such output level can be a voltage, a current or a combination of both voltage and current. The input may be coupled to obtain a threshold value. The input may be coupled to be susceptive to a feedback signal. The threshold value can be a turnoff threshold value. In some cases, the deposition apparatus may comprise a power supply regulator. The power supply regulator may comprise a comparator. The output of the comparator may comprise a feedback state signal. Such a signal may function as a digital on or off signal or an enable signal to the control circuit. If the input signal is larger in value than the threshold value, the output feedback state signal may be in a first state. The input signal may be characteristic of the output level of the power supply. However, if the input signal is smaller in value than threshold value, the output feedback state signal may be in a second state. In some cases, one of the first and second states of the feedback state signal can be a logical high value and the other one of the first and second states of the feedback state signal may be a logical low value. The feedback state signal can be coupled to be received by the control circuit. Such control circuit may aid in control of the power supply regulation. The control circuit can also comprise a current limit circuit. The current limit circuit may be coupled to receive a current sense signal from the power switch. The current sense signal may be indicative of the current that passes through the power switch. In some cases, the control circuit can also comprise the current sense signal to aid in the control regulation of the power supply.

In some cases, the feedback signal may be used to measure the amount of the output power supply that is above or below a predetermined value by comparing the inputs of a comparator. One or more waveforms may be internal to the control circuit, the feedback signal, and the switch current of the power supply regulator. Such waveforms may be varied during modulation to form at least one modulation signal. The method of variation may be selected from the group consisting of analog modulation methods, digital modulation methods, and pulse modulation methods. Analog modulation methods may be selected from the group consisting of amplitude modulation, angle modulation, double-sideband modulation, double-sideband modulation with carrier, double-sideband suppressed-carrier transmission, double-sideband reduced carrier transmission, single-sideband modulation, single-sideband modulation with carrier, single-sideband modulation suppressed carrier modulation, vestigial sideband modulation, quadrature amplitude modulation, frequency modulation, phase modulation, and transpositional modulation. Digital modulation methods may be one or more techniques selected from the group consisting of phase-shift keying (PSK), Binary PSK, Quadrature PSK (QPSK), 8PSK, 16PSK, differential PSK, Differential QPSK, Offset QPSK, π/4-QPSK, frequency-shift keying, audio frequency-shift keying, multi-frequency shift keying (M-ary FSK), dual-tone multi-frequency, amplitude-shift keying, on-off keying, M-ary vestigial sideband modulation (such as 8VSB), quadrature amplitude modulation, polar modulation, continuous phase modulation, minimum-shift keying, Gaussian minimum-shift keying, continuous-phase frequency-shift keying, orthogonal frequency-division multiplexing, discrete multi-tone, wavelet modulation, trellis coded modulation, spread-spectrum techniques, direct-sequence spread spectrum, chirp spread spectrum, and frequency-hopping spread spectrum. Pulse modulation methods may be one or more techniques selected from the group consisting of analog-over-analog methods, pulse-amplitude modulation, pulse-width modulation, pulse-depth modulation, pulse-position modulation, analog-over-digital methods, pulse-code modulation (PCM), differential PCM (DPCM), adaptive DPCM, delta modulation, delta-sigma modulation, continuously variable slope delta modulation, and pulse-density modulation. Other types of modulation techniques may be selected from the group consisting of continuous wave (CW) operation, adaptive modulation, and space modulation.

In some cases, the deposition apparatus may comprise an adjustment circuit, which comprises a state machine coupled to a modulator. The adjustment circuit can also comprise a component coupled to the modulator. Such a component may be coupled in a manner to deliver the feedback signal. The component may be coupled to combine the modulation signal that is determined from the modulator with the feedback signal to the input of the comparator. As a result, the feedback signal may be outputted from the component and is compared with the threshold value at the input may be adjusted with the modulation signal.

In some cases, the feedback signal may comprise a pulse width modulation (PWM) signal. The pulse width modulation signal may be used to break up oxides on the surface of the at least a portion of the 3D object. The PWM signal can be used to mix portions of the 3D object using Lorentz forces. The resulting alternating current (AC) power supply may be more consistent despite varying the resistance or capacitance due to various printing issues, such as print plate warping. The PWM signal may comprise an amplitude and a width per duration. The PWM may be used to alter amplitude and width per duration. Varying the duration can alter the composition the waveform. The composition may be the frequency of the waveform. PWM may alter the pulses of the 3D printer rather than slow variation of the signal. PWM can create time varying direct forces that can mix the deposition. The time varying forces may be magnetic fields. In some cases, the control loop can comprise electric currents. The electric current may be an alternating current or a direct current. In some cases, the feedback signal may be a periodic waveform or a fourier series. The feedback signal may be analyzed using a fourier series. The periodic waveform may be selected from the group consisting of sine wave, square wave, triangle wave, and sawtooth wave. In some cases, the periodic waveform may be slowly varying.

In some cases, the control of the application of electric current may be used to influence the deposition of segments. Open-loop control of the applied current may be enabled via selection of the intensity of power along with the duration prior to deposition. The intensity level may be calibrated to achieve a specific voltage or current at a constant resistance. However, the resistance may vary at each deposition site, as well as vary during the segment deposition. Open-loop control may result in the application of too much or too little heat during deposition, and the fusion between segments may be affected. With proper calibration, open-loop control may be used successfully for deposition.

In some cases, closed-loop control is used. During closed-loop control, the voltage and current may be measured during deposition, and the resistance may be calculated according to Equation 2 (i.e., Ohm's Law).

R=V/I Equation 2

Because the resistance may be calculated dynamically, the power of the applied electric current may be precisely controlled, thus resulting in the exact amount of heat being applied during deposition to achieve the deposition parameters and/or segment characteristics. An AC voltage from 0.001 V to 1000 V or 0.01 V to 100 V may be applied in addition to the DC current of the deposition circuit to determine the impedance response of the system. The impedance may also be measured dynamically and used for feedback control. Closed-loop control may beneficially eliminate failed parts due to incomplete fusion of segments and minimize heat input into the structure during deposition.

In some cases, heating is performed by keeping the voltage fixed and adjusting the current. The current may be direct current or alternating current. Alternatively, the current may be fixed and the voltage may be increased to induce heating.

In some cases, the voltage may be at least about 0.001 V, 0.01 V, 0.1 V, 1 V, 10 V, 20 V, 30 V, 40 V, 50 V, 60 V, 70 V, 80 V, 90 V, 100V, 110V, 120V, 130V, 140V, 150V, 160V, 170 V, 180 V, 190 V, 200 V, 210 V, 220 V, 230 V, 250 V, 300 V, 400 V, 500 V, 1000 V, or more. In some cases, the voltage may be less than or equal to about 2000 V, 1000 V, 500 V, 400 V, 300 V, 250 V, 230 V, 220 V, 210 V, 200 V, 190V, 180V, 170V, 160V, 150V, 140V, 130V, 120V, 110 V, 100 V, 90 V, 80 V, 70 V, 60 V, 50 V, 40 V, 30 V, 20 V, 10 V, 1 V, 0.1 V, 0.01 V, 0.001 V, or less.

In addition to the data that may be measured from the electric circuit of the deposition (i.e., the circuit formed by the base 130 and feedstock 120 via controller 145 and power supply 140), additional sensors may be utilized to gather complementary data. Temperature measurements of the deposition site on the base 130 or other points on the printed part or apparatus 100 may be measured using contact sensors such as thermocouples or thermistors, and non-contact methods such as infrared (IR) sensors and optical pyrometry. Temperature data may then be used by the system control loop to ensure the deposition parameters.

Other sensors may be used to measure and/or analyze the build surface (e.g., the base 130 or the previously deposited layer of segments of the part being printed). Sonar or capacitive response systems may be used to map the surface and detect any areas that are not in specification, allowing for corrective action (e.g., rework such as additional segment deposition in areas having high porosity or missing material). All the data collected for feedback control may also be logged and then analyzed at the network level to develop automatic calibration processes to improve the function of any connected apparatus 100.

To take advantage of the segment-by-segment deposition mechanism in methods and systems of the present disclosure, the design process may be tailored to make use of a voxel system. The 3D rendering module 155 may assign properties to certain sections of the part based the deposition parameters using, e.g., computer-aided design (CAD) software. For example, if an internal section of a part may be porous to act as a filter, that section in the CAD design may be selected, and the user may assign values to parameters such as the appropriate percent porosity. In tandem with the voxel-based extension for the 3D rendering module 155, computer-aided manufacturing software may be utilized to translate the appropriate voxel properties into the toolpath and deposition parameters required to produce the user's CAD design.

Another example of a voxel-based design is the design of a heat sink. In the CAD design utilized by the 3D rendering module 155, the user may specify properties such as the material and density to direct heat through a specific area of the part. This concept may be used to keep heat-sensitive areas of the same part cool, without having to make the part from multiple pieces or via multiple different depositions. The voxel-based design system may also be leveraged with control of surface textures of either external or internal surfaces. A surface may intentionally be made with a very high surface area through increased roughness to give a part a high-friction surface, a highly radiant surface to cool more effectively, give an electrode higher conductivity, or allow for enhanced adhesion of a surface coating.

To deposit segments in precise locations, the feedstock electrode 120 and base 130 may be positioned with computer-controlled mechanical actuators 110, 135. There are many mechanical systems that may accomplish the required motion, using a combination of electric, hydraulic or pneumatic motors and linear actuators, belts, pulleys, lead screws, and other devices. In some cases, the feedstock electrode 120 is situated on a gantry system 105 that allows motion in the X and Y directions, as described above. The base electrode 130 may move independently on the Z axis. The feed of feedstock 120 may be controlled by another independent actuator controlling source 125. The timing, duration, and power of the electric current used for deposition are controlled by controller 145. The formation of a structure, controlled by signals from controller 145, may proceed according to the following example. The structure is a simple cube, formed from eight segments each having a diameter of 1 unit.

1. The gantry 105 moves feedstock 120 to the first position (X0,Y0) in the XY plane.

2. The base 130 moves to a position close to the tip of the feedstock 120 in the Z axis (Z0).

3. Feedstock 120 is fed from source 125 until it contacts the base 130.

4. Electric current flows through the electrodes (i.e., the base 130 and feedstock 120), melting the tip of the feedstock 120 and forming a metal segment on the base 130.

5. The gantry 105 moves the feedstock 120 to the next position in the XY plane (X1,Y0).

6. Feedstock 120 is fed to contact the base 130, current is passed, and another segment is formed.

7. The gantry 105 moves the feedstock 120 in the XY plane and forms two more segments at X1, Y1 and X0, Y1.

8. The base 130 moves one unit away from the feedstock 120 (Z1).

9. The gantry 105 moves the feedstock 120 to (X0,Y0), feedstock 120 is fed from source 125 until it makes contact with the segment underneath, and a new segment is formed on top of the previously deposited segment.

10. The gantry 105 moves the feedstock 120 to each remaining XY position again in order, depositing a segment at each on top of the previous layer.

The segment may be a voxel or a continuous linear segment. Deposition of the continuous linear segment may comprise simultaneous motion of the feedstock feed and gantry while current is being fed. The metal-based additive manufacturing process in accordance with methods and systems of the present disclosure may be combined with other tools and/or processes in a single machine. Examples of this are a gantry-type machine as described above with a polymer extruder tool and a milling cutter tool attached to the gantry alongside the metal deposition tool. In this manner, hybrid structures may be built from a combination of polymer and metal, using the combination to increase the speed of building the structure, reduce the cost of the structure, or using the material that has the appropriate properties for that portion of the structure. For example, a part fabricated in accordance with methods and systems of the present disclosure may have a structure that is largely built from a non-conductive polymer but that also features internal printed metallic electric circuits. The milling cutter may be used to machine any precision surfaces required on the structure. This concept may be expanded to include any number of tools in a single machine to perform any operation required for the formation of the required structure.

Multiple parts may be produced in succession in an automated fashion with no human user involvement. After a part is complete, an arm may cross the base 130 and remove the part, depositing it into a collection area. Once the base 130 is cleared of the previous part and the removal arm, the next part may be fabricated.

In some cases, calculations for the deposition parameters performed by 3D rendering module 155 are based on a static diameter value for the feedstock or polymer filament. However, the diameter of the supplied filament may be variable, as described above, and these variations may cause poor printing performance, jamming/clogging of the feedstock feeder 115 (e.g., a print head), or in severe cases damage to mechanical systems of apparatus 100. It may also be desirable to detect the absence of feedstock 120 to determine when the source 125 has been exhausted. Additionally, a precise measure of the absolute length of feedstock 120 consumed may be logged and used to develop algorithms to better project the total feedstock 120 required and the time to complete a print.

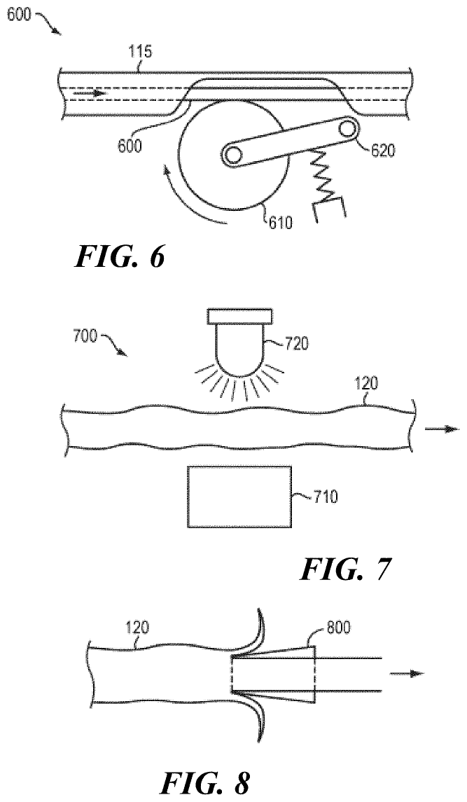

In various methods and systems of the present disclosure, in order to sense and track the use of feedstock 120 (or its absence), the apparatus 100 incorporates a system that includes or consists essentially of either a mechanical wheel that is in contact with the feedstock 120, or an optical system that has an unimpeded view of the 120. FIG. 6 schematically depicts a mechanical feedstock-tracking system 600 that includes a wheel 610 that contacts the feedstock 120 at a point within the feedstock feeder 115 as the feedstock 120 is fed from source 125 during printing. The motion of the feedstock 120 may be recorded by a digital encoder connected to the wheel 610. The amount of feedstock 120 utilized during a period of time may be calculated from the encoder readout. As shown, the wheel 610 may be connected to a mechanism such as a spring-loaded lever 620 that urges the wheel 610 against the feedstock 120. In this manner, deflections of the lever 620 may be used to calculate the diameter of the feedstock 120. Absence of wheel motion or a very small diameter measurement will typically indicate that the source 125 has been emptied of feedstock 120.

FIG. 7 depicts an optical feedstock-tracking system 700 that may be incorporated into various methods and systems of the present disclosure. An optical image sensor 710 may be utilized to determine movement in of the feedstock 120 based on microscopic changes in the feedstock's surface and therefore be used to measure absolute length of feedstock 120 utilized during a printing process. A light 720 angled on the backside of the feedstock 120 facing the sensor 710 may be used to measure the diameter of the feedstock 120 based on the area of light blocked by the feedstock 120. Multiple sensors 710 may be used to provide more accurate measurements in multiple axes with respect to the feedstock 120. Similar to the feedstock-tracking system 600, the motion and diameter of the feedstock 120, for example, may be used to track the feedstock to calculate total length of feedstock utilized, and/or detect when source 125 is out of feedstock.

The methods and systems of the present disclosure may also incorporate an anti jamming mechanism to prevent drastically oversized feedstock from causing a jam or other damage to the feedstock feeder (e.g., the print head thereof). For example, a ring having an inside diameter matching the maximum allowable feedstock diameter may be disposed within the feedstock feeder 115 or between the feedstock feeder 115 and the source 125. The feedstock 120 may be passed through the ring, and if it is oversized, the feedstock may become stuck in the ring or otherwise be unable to pass through the feeder 115 for printing. This condition may be sensed by (e.g., feedstock-tracking system 600 or 700), and reported to the operator. Additionally, FIG. 8 depicts an embodiment of such a ring 800. As shown, ring 800 may have a sharp edge on the inner diameter so that the feedstock 120 may be automatically trimmed to the proper diameter as it passes through the ring 800.

Some printed parts, particularly those having high densities and/or variable or complicated geometries, may be difficult to remove from the base 130 after printing. In various embodiments of the present disclosure, a sacrificial structure (or “raft”) may be printed on the base 130 before the part and utilized to enable removal of the part from the base 130. In various embodiments, the structure of the raft is selected to facilitate anchoring of the part to the base 130 and enable electrical conductivity between the part (i.e., the feedstock electrode) and the base 130 while facilitating removal of the raft from the finished part after printing. Furthermore, rafts having the same size and/or shape and/or interior configuration may be utilized for parts having very different geometries, thereby enabling a standardized process for removal of different parts from the base 130—after printing, the raft (and the printed part) is removed from the base 130, and then the raft is removed from the part. In some cases, the raft may include, consist essentially of, or consist of, e.g., metal and/or polymer. The raft may not be printed by the apparatus 100 but is provided by other approaches (e.g., fabricated by another apparatus and affixed (e.g., adhered) to the base 130 prior to printing of a part). In some cases, the raft includes, consists essentially of, or consists of one or more materials different from that utilized to fabricate a part thereon. For example, feedstocks including, consisting essentially of, or consisting of different metals may be utilized to print the raft and to print one or more parts.

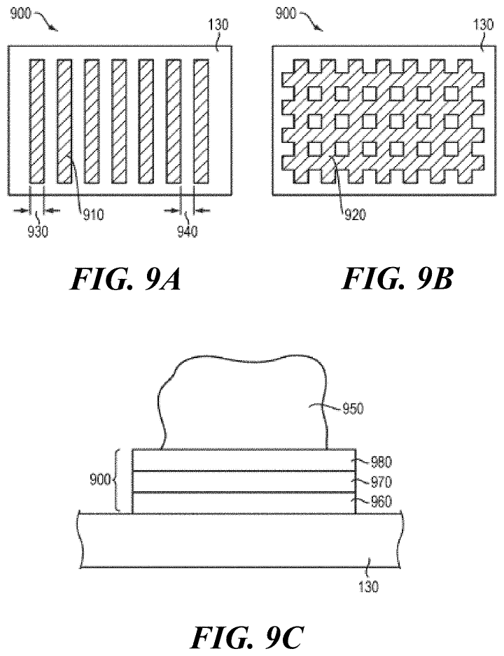

FIGS. 9A and 9B are schematic top views of rafts 900 fabricated in accordance with methods and systems of the present disclosure. As shown, the raft may include or consist essentially of one or more layers of material printed (e.g., using feedstock 120) over the base 130 before printing of the part. In order to facilitate subsequent removal of the raft from the printed part, the raft may be composed of, e.g., a series of stripes 910 or a grid pattern 920 of the printed material, as shown in FIGS. 9A and 9B. That is, in various embodiments, the raft 900 defines one or more openings there through that extend between the base 130 and a part printed over the raft 900, rather than the raft 900 being composed of a solid sheet of material. The raft 900 may be printed utilizing a feedstock 120 that corresponds to the feedstock 120 (i.e., the same material and/or the same feedstock diameter and/or deposition conditions) utilized to print the part over the raft 900, or the raft 900 may be printed utilizing a different material, different feedstock diameter, and/or different deposition conditions (e.g., feedstock withdrawal rate).

In some cases, the raft 900 is at least partially composed of printed areas having thicknesses 930 with gaps 940 there between. The sizes of thicknesses 930 and/or gaps 940 may be selected to control the adhesion between the raft 900 and the printed part and/or the base 130. Instead or in addition, the height (i.e., vertical thickness) of all or a portion of the raft 900 may be selected to facilitate subsequent printing of a part there over. FIG. 9C depicts a part 950 printed over a raft 900 composed of one or more bottom layers 960, one or more middle layers 970, and one or more top layers 980. The bottom layer 960 may have a thickness greater than the layer thickness typically utilized for printing parts in order to, e.g., isolate the part from any roughness or unevenness of the surface of the base 130. For example, if printed parts are typically composed of layers having thicknesses of approximately 0.6 mm, then at least the bottom layer 960 of the raft 900 may have a thickness greater than 0.6 mm, e.g., greater than 1 mm, or even thicker. The raft 900 in FIG. 9C also contains one or more middle layers 970 that may not mechanically contact either the base 130 or the part 950. The middle layer(s) 970 may, for example, provide structural stability to the raft 900 while also providing electrical conductivity through the raft 900. The top layer 980 may have a structure designed to control the amount of adhesion between the raft 900 and part 950 printed over the raft. For example, the porosity of top layer 980 and/or the size of gaps 940 of the top layer 980 may be increased to decrease the amount of surface area at the interface (and thus the adhesion) between the raft 900 and the part 950.

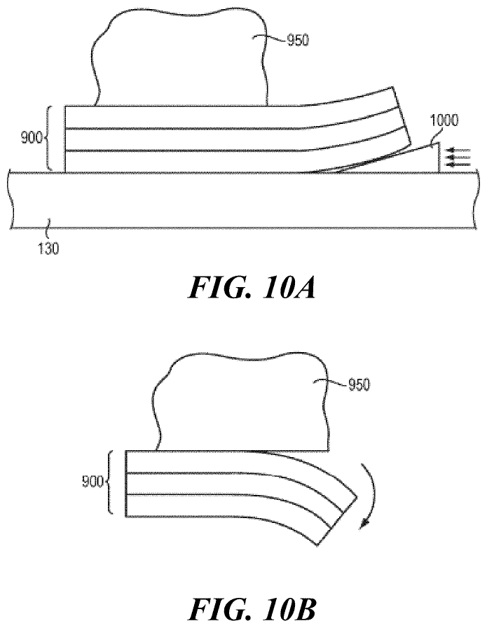

Once the part 950 has been printed as detailed herein, the part 950 and the raft 900 may be separated from the base 130. FIG. 10A illustrates an embodiment in which a blade 1000 is utilized to separate the raft 900 from the base 130. As shown in FIG. 10B, after separation of the raft 900 from the base 130, the raft may be peeled away from the part 950.

In some cases, the apparatus 100 may be a single “station” along an assembly line of modular automated manufacturing stations in order to leverage the automation capabilities of apparatus 100. For example, a part may be printed utilizing an apparatus 100 and then automatically transferred (via, e.g., a conveyor belt, robotic handler, or similar system) to a finishing station (e.g., rock tumbler, vibration box, bead blasting cabinet and/or to a cleaning station for automatic sterilization (e.g., with UV light, chemicals). The part may then be transferred into a wrap station (e.g., a plastic wrap station), and then to a packaging station with an automatic labeler that labels the boxed parts as they exit. A parallel assembly line may produce packing material for the printed part. For example, a mold of the printed part may be utilized to shape packaging foam such that it is form-fitted to the finished part. The shaped foam may be fed into the packaging system along with a box in the main assembly line.

In some cases, feedstock-tracking systems such as feedstock-tracking systems 600, 700, as well as rafts (e.g., raft 900) and/or other portions of apparatus 100 may be utilized with feedstocks composed of non-metallic materials (e.g., plastic) and/or to print non-metallic (e.g., plastic) objects.

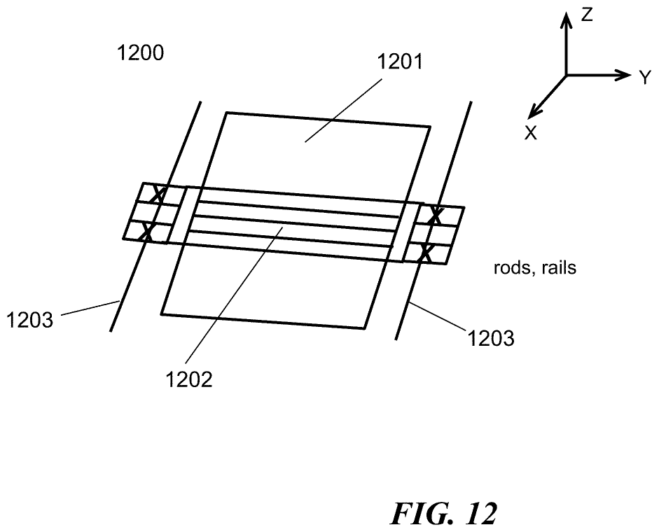

In some cases, feedstock, such as sheet metal or metal ribbon, may be used as raw material to parallelize the printing process. FIG. 12 illustrates parallelization of a metal additive deposition 1200 in the Y direction on a build plate 1201 to produce a printing array 1202 using a deposition apparatus. The printing may be resistive printing (e.g. Joule printing). The build plate 1201 may comprise at least one rod or rail 1203 on either side of the build plate 1201. The at least one rod or rail 1203 provides a closed linear motion. In some cases, a contact tip of the deposition apparatus may supply the current. There may be selective motion control of each raw material (e.g., feedstock) in the Z-direction using individual contact tips to selectively drive the current. Multiple thickness or variable thickness of the raw material (e.g., feedstock) may be used.

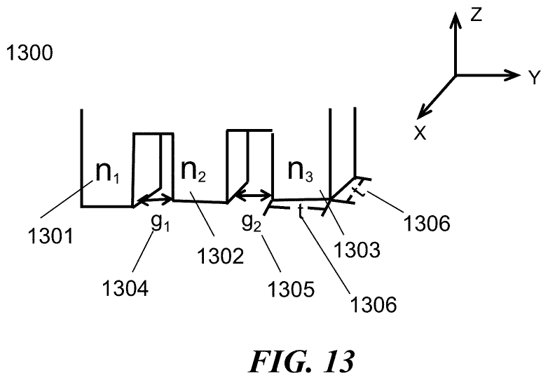

In some cases, the parallelization of the printing process may comprise multiple nodes in order to obtain high resolution. This may result in the manufacture of fully dense parts. Industry standard feedstock, such as sheet metal or metal foils, may be used as the raw materials. Rolls of feedstock may be transformed into ribbons prior to printing. For a feedstock to print simultaneously and selectively, the node to be deposited at each location along the Y-axis may be controlled in subsystem 1300 (FIG. 13). The subsystem 1300 comprises three nodes 1301, 1302, and 1303. Nodes 1301 and 1302 are separated by a gap 1304. Nodes 1302 and 1303 are separated by a gap 1305. For a feedstock of length L, thickness t (1306), and modulus y, the resolution may be optimized to be a cubic (t³). L may be greater than t, n may be the number of nodes, and g may be the gap length between each node. In such instance, the length of the feedstock may be calculated according to Equation 3.

L=nt+(n−1)g Equation 3

Variable g may be required for selective parallelization of printing deposition of the feedstock. In some cases, the minimum value of g may be dependent on the dielectric constant of the feedstock. The gap area necessary to measure the dynamic gap capacitance may be calculated according to Equation 4.

Gap area=gₙ×tₙ Equation 4

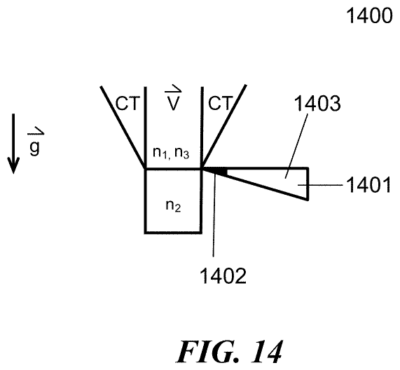

The capacitance effects within a continuous sheet in FIG. 13 may be overcome and if nodes 1 and 3 are deposited by not node 2, then the motion of each node may be discretely controlled or a uniform node length may be ensured before each deposition. In either case, there may be a purge requirement. For this requirement, there may be a cutting tool parallel to the build plate and perpendicular to the motion of the feedstock in system 1400 (FIG. 14). The cutting tool 1401 may be an active or passive cutting tool. Active or passive cutting tools may be selected from the group consisting of laser, wire electrical discharge machining (EDM), and shears. The cutting tool may be a guillotine type of blade mechanism. In some cases, the cutting tool may comprise a sharp hard cutting zone 1402 and a tough heat resistant zone 1403. In some cases, the removed material can comprise gravity issues as the cut material falls onto the workpiece. As a result, the purge area outside of the build volume may be purged or the part may be printed upside down. Alternatively, the part may be printed sideways so that the gravity g is parallel to the voltage v, resulting in the cut material falling away from the workpiece. In some cases, a high suction vacuum, magnet, and/or electric field may be used to remove the cut material against gravity.

In some cases, ribbons may be generated from sheets to cost effectively parallelize the printing process. The sheet metal may be used as the feedstock for large scale industrial applications. When each node is moved individually, each ribbon may be fed individually for each node. In some cases, an internal system may be utilized, which converts sheet metal into ribbon. Shearing may be used for such conversions by mechanically cutting sheets into ribbons. In other instances, a laser array may be employed, which uses a high energy laser array to cut the sheets into ribbons. Alternatively, wire EDM, plasma cutter array, or a band saw array may be used for cutting.

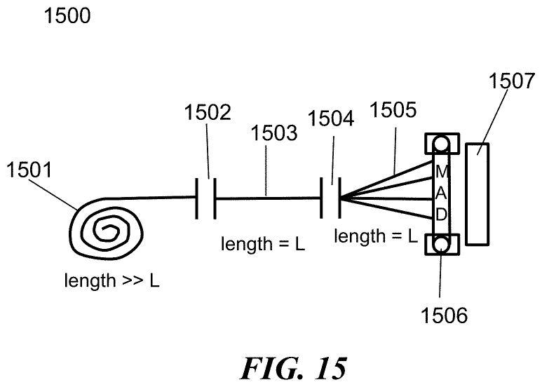

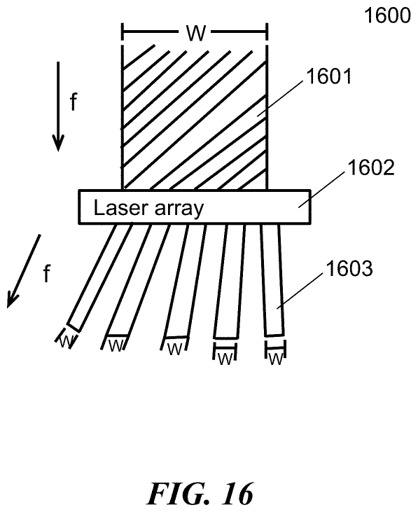

In some cases, a part may be thin on one side and thick on the other side. The thin side may under-utilize node 1 and the thick side may over utilize node 3. In such circumstances, the continuous spool of sheet metal may not be appropriate as non-uniform printing is occurring. FIG. 15 depicts a subsystem 1500 that can cut 1502 a sheet spool 1501 into small sheets 1503, which can cut 1504 the small sheet 1503 further into ribbons 1505, which may be fed into a selective printing contact tip array 1506 and then printed onto a build plate 1507. FIG. 16 depicts a subsystem 1600 in which ribbons 1603 are cut from a sheet 1601 by a laser array 1602. The cutting array may be selected from the group consisting of shear array, wire EDM array, ultrasonic vibration array, plasma cutter array, and/or band saw array. The width of the metal sheet W may be calculated according to Equation 5 in which w is the width of each ribbon and n is the number of ribbons. The volumetric flow rate may be calculated by Equation 6 in which t is the thickness of the ribbons and f is the feed rate (e.g., meters/second).

W=n×w Equation 5

Volumetric flow rate=W×t×f=w×n×t×f Equation 6

Each deposition may have the geometric properties presented above.

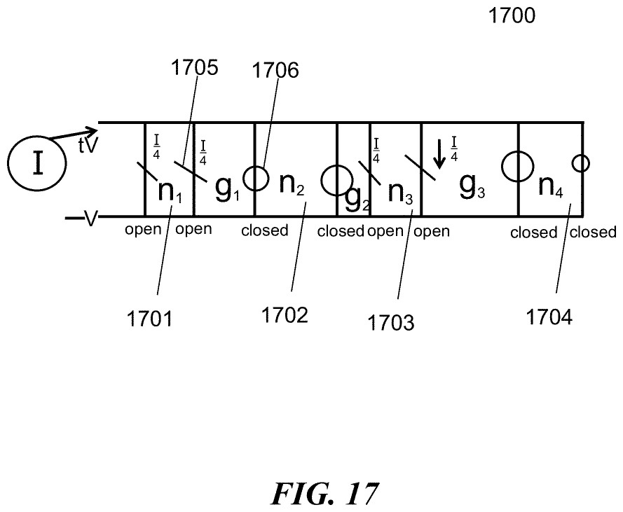

The mechanical control may map to the electric current control. The current may be selectively set, monitored, and controlled at each node. Analog power electronics may be used for power control at each node using digital logic to control when and how much current flows at each node. FIG. 17 illustrates a parallel circuit design 1700 in which current is flown 1705 through n₁ 1701 and n₃ 1703 and in which no current 1706 flows though n₂ 1702 and n₄ 1704. When n₁ 1701 and n₃ 1703 feed and contact the build plate, a deposition may form. In contrast, deposition may not occur at n₂ 1702 and n₄ 1704 because they are not fed and there is no current flow. In FIG. 17, n₁ 1701 and n₃ 1703 both receives I/2 amps of current. General circuit designs may not be ideal for the printing process control system as it may limit the deposition flexibility. For example, if n₁ 1701 and n₃ 1703 are deposited onto dissimilar metals, different current may be provided to n₁ 1701 and n₃ 1703 in order to achieve desired metallurgic properties. As a result, the current flow may be precisely set and controlled to each node separately.

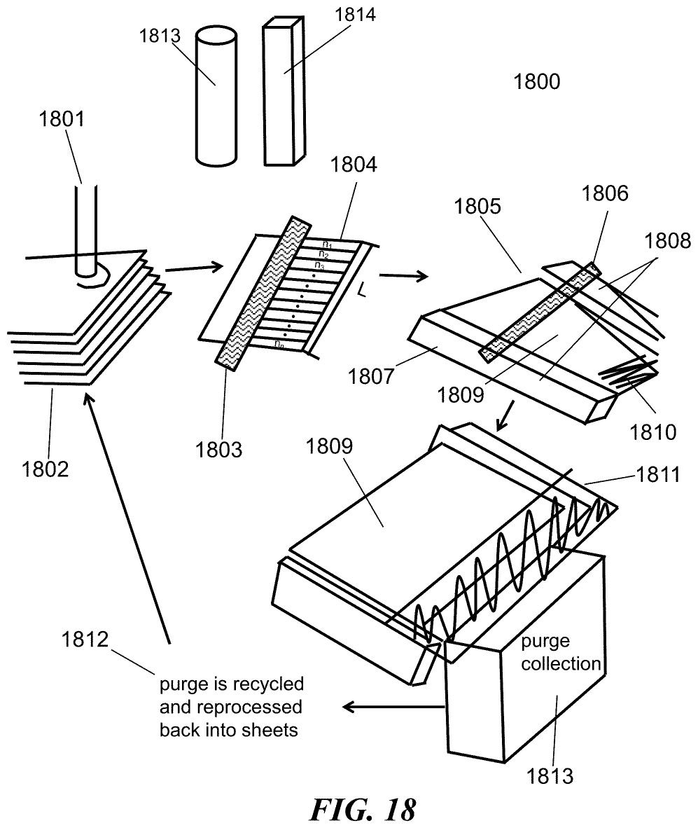

In some cases, a serial deposition head may be used with any shape feedstock. A parallel array of deposition heads may be used to increase deposition speed. When sheet metal is used, unused material may be purged as shown in the system 1800 of FIG. 18. A feedstock 1802 may be fed into a deposition machine. The feedstock 1802 may be selected from the group consisting of round wire 1813, square extrusion wire 1814, sheet metal strips, and sheet metal spools. Prior to feeding the feedstock into the deposition machine, the feedstock may be pre-processed using various handling methods and devices 1801 such as magnets, suction, manual, and/or friction roller. The feedstock 1802 may be fed into the separator 1803 and sheets of feedstock may be cut into multiple ribbons 1804. After the parallel array of cutting heads create ribbon strips to be fed into the one or more deposition head (e.g., parallel deposition heads), deposition may commence 1805. The one or more deposition heads may selectively deposit metal voxels 1806 onto a build plate 1809 as the one or more deposition heads move perpendicular to the rails and rods 1808. Once the one or more deposition heads move one voxel length 1807, the process may be repeated until the 3D object is built 1810. Next, the deposition head may move to a purge area 1813 when one strip of metal is depleted and other strands may be purged to make way for a new sheet 1811. The purged metal may be recycled and reprocessed for re-use and other uses 1812.

### Computer Systems

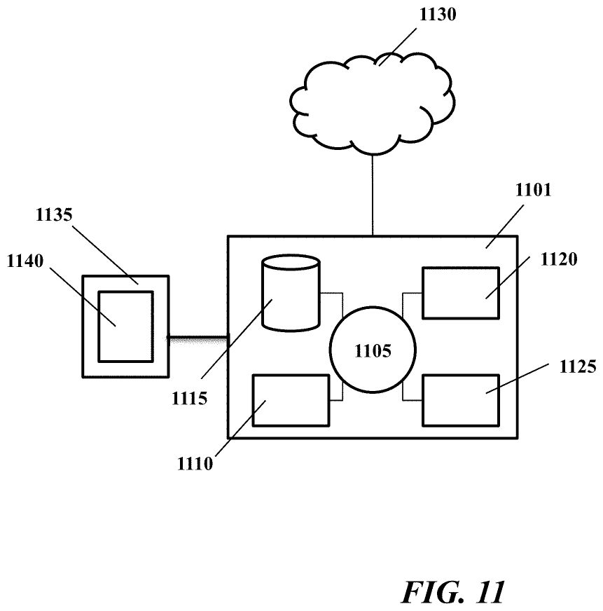

The present disclosure provides computer systems that are programmed to implement methods of the disclosure. FIG. 11 shows a computer system 1101 that is programmed or otherwise configured to implement 3D printing methods and systems of the present disclosure. The computer system 1101 can regulate various aspects of the methods of the present disclosure, such as, for example, printing at least a portion of a 3D object adjacent to a base.

The computer system 1101 includes a central processing unit (CPU, also “processor” and “computer processor” herein) 1105, which can be a single core or multi core processor, or a plurality of processors for parallel processing. The computer system 1101 also includes memory or memory location 1110 (e.g., random-access memory, read-only memory, flash memory), electronic storage unit 1115 (e.g., hard disk), communication interface 1120 (e.g., network adapter) for communicating with one or more other systems, and peripheral devices 1125, such as cache, other memory, data storage and/or electronic display adapters. The memory 1110, storage unit 1115, interface 1120 and peripheral devices 1125 are in communication with the CPU 1105 through a communication bus (solid lines), such as a motherboard. The storage unit 1115 can be a data storage unit (or data repository) for storing data. The computer system 1101 can be operatively coupled to a computer network (“network”) 1130 with the aid of the communication interface 1120. The network 1130 can be the Internet, an internet and/or extranet, or an intranet and/or extranet that is in communication with the Internet. The network 1130 in some cases is a telecommunication and/or data network. The network 1130 can include one or more computer servers, which can enable distributed computing, such as cloud computing. The network 1130, in some cases with the aid of the computer system 1101, can implement a peer-to-peer network, which may enable devices coupled to the computer system 1101 to behave as a client or a server.

The CPU 1105 can execute a sequence of machine-readable instructions, which can be embodied in a program or software. The instructions may be stored in a memory location, such as the memory 1110. The instructions can be directed to the CPU 1105, which can subsequently program or otherwise configure the CPU 1105 to implement methods of the present disclosure. Examples of operations performed by the CPU 1105 can include fetch, decode, execute, and writeback.

The CPU 1105 can be part of a circuit, such as an integrated circuit. One or more other components of the system 1101 can be included in the circuit. In some cases, the circuit is an application specific integrated circuit (ASIC).

The storage unit 1115 can store files, such as drivers, libraries and saved programs. The storage unit 1115 can store user data, e.g., user preferences and user programs. The computer system 1101 in some cases can include one or more additional data storage units that are external to the computer system 1101, such as located on a remote server that is in communication with the computer system 1101 through an intranet or the Internet.

The computer system 1101 can communicate with one or more remote computer systems through the network 1130. For instance, the computer system 1101 can communicate with a remote computer system of a user (e.g., customer or operator of a 3D printing system). Examples of remote computer systems include personal computers (e.g., portable PC), slate or tablet PC's (e.g., Apple® iPad, Samsung® Galaxy Tab), telephones, Smart phones (e.g., Apple® iPhone, Android-enabled device, Blackberry®), or personal digital assistants. The user can access the computer system 1101 via the network 1130.

Methods as described herein can be implemented by way of machine (e.g., computer processor) executable code stored on an electronic storage location of the computer system 1101, such as, for example, on the memory 1110 or electronic storage unit 1115. The machine executable or machine readable code can be provided in the form of software. During use, the code can be executed by the processor 1105. In some cases, the code can be retrieved from the storage unit 1115 and stored on the memory 1110 for ready access by the processor 1105. In some situations, the electronic storage unit 1115 can be precluded, and machine-executable instructions are stored on memory 1110.

The code can be pre-compiled and configured for use with a machine having a processer adapted to execute the code, or can be compiled during runtime. The code can be supplied in a programming language that can be selected to enable the code to execute in a pre-compiled or as-compiled fashion.

Aspects of the systems and methods provided herein, such as the computer system 1101, can be embodied in programming. Various aspects of the technology may be thought of as “products” or “articles of manufacture” typically in the form of machine (or processor) executable code and/or associated data that is carried on or embodied in a type of machine readable medium. Machine-executable code can be stored on an electronic storage unit, such as memory (e.g., read-only memory, random-access memory, flash memory) or a hard disk. “Storage” type media can include any or all of the tangible memory of the computers, processors or the like, or associated modules thereof, such as various semiconductor memories, tape drives, disk drives and the like, which may provide non-transitory storage at any time for the software programming. All or portions of the software may at times be communicated through the Internet or various other telecommunication networks. Such communications, for example, may enable loading of the software from one computer or processor into another, for example, from a management server or host computer into the computer platform of an application server. Thus, another type of media that may bear the software elements includes optical, electrical and electromagnetic waves, such as used across physical interfaces between local devices, through wired and optical landline networks and over various air-links. The physical elements that carry such waves, such as wired or wireless links, optical links or the like, also may be considered as media bearing the software. As used herein, unless restricted to non-transitory, tangible “storage” media, terms such as computer or machine “readable medium” refer to any medium that participates in providing instructions to a processor for execution.

Hence, a machine readable medium, such as computer-executable code, may take many forms, including but not limited to, a tangible storage medium, a carrier wave medium or physical transmission medium. Non-volatile storage media include, for example, optical or magnetic disks, such as any of the storage devices in any computer(s) or the like, such as may be used to implement the databases, etc. shown in the drawings. Volatile storage media include dynamic memory, such as main memory of such a computer platform. Tangible transmission media include coaxial cables; copper wire and fiber optics, including the wires that comprise a bus within a computer system. Carrier-wave transmission media may take the form of electric or electromagnetic signals, or acoustic or light waves such as those generated during radio frequency (RF) and infrared (IR) data communications. Common forms of computer-readable media therefore include for example: a floppy disk, a flexible disk, hard disk, magnetic tape, any other magnetic medium, a CD-ROM, DVD or DVD-ROM, any other optical medium, punch cards paper tape, any other physical storage medium with patterns of holes, a RAM, a ROM, a PROM and EPROM, a FLASH-EPROM, any other memory chip or cartridge, a carrier wave transporting data or instructions, cables or links transporting such a carrier wave, or any other medium from which a computer may read programming code and/or data. Many of these forms of computer readable media may be involved in carrying one or more sequences of one or more instructions to a processor for execution.

The computer system 1101 can include or be in communication with an electronic display 1135 that comprises a user interface (UI) 1140 for providing, for example, a print head tool path to a user. Examples of UI's include, without limitation, a graphical user interface (GUI) and web-based user interface.

Methods and systems of the present disclosure can be implemented by way of one or more algorithms. An algorithm can be implemented by way of software upon execution by the central processing unit 1105. The algorithm can, for example, partition a computer model of a part and generate a mesh array from the computer model.

The computer system 1101 can include a 3D printing system. The 3D printing system may include one or more 3D printers. A 3D printer may be, for example, a fused filament fabrication (FFF) printer. Alternatively or in addition to, the computer system 1101 may be in remote communication with the 3D printing system, such as through the network 1130.

While preferred embodiments of the present invention have been shown and described herein, it will be obvious to those skilled in the art that such embodiments are provided by way of example only. It is not intended that the invention be limited by the specific examples provided within the specification. While the invention has been described with reference to the aforementioned specification, the descriptions and illustrations of the embodiments herein are not meant to be construed in a limiting sense. Numerous variations, changes, and substitutions will now occur to those skilled in the art without departing from the invention. Furthermore, it shall be understood that all aspects of the invention are not limited to the specific depictions, configurations or relative proportions set forth herein which depend upon a variety of conditions and variables. It should be understood that various alternatives to the embodiments of the invention described herein may be employed in practicing the invention. It is therefore contemplated that the invention shall also cover any such alternatives, modifications, variations or equivalents. It is intended that the following claims define the scope of the invention and that methods and structures within the scope of these claims and their equivalents be covered thereby.

1.-63. (canceled)

64. A method for printing a three-dimensional (3D) object adjacent to a base, comprising:
(a) calculating at least one deposition parameter based at least in part on a computational representation of said 3D object;
(b) using a print head to initiate printing of said 3D object in accordance with said at least one deposition parameter, wherein said printing comprises subjecting at least one feedstock to heating upon flow of electrical current through said at least one feedstock and into said base, or vice versa, which heating is sufficient to melt at least a portion of said at least one feedstock;
(c) while printing said 3D object with said print head, (i) measuring one or more properties of said 3D object or said at least one feedstock and (ii) determining whether said one or more properties of said 3D object measured in (i) meet one or more predetermined properties of said 3D object or said at least one feedstock;
(d) adjusting said at least one deposition parameter upon determining that said one or more properties of said 3D object or said at least one feedstock measured in (c) do not meet said one or more predetermined properties, to yield at least one adjusted deposition parameter; and
(e) using said print head and said at least one adjusted deposition parameter to continue to print said 3D object.

65. The method of claim 64, wherein said one or more predetermined properties is generated by simulating said 3D object.

66. The method of claim 64, wherein said at least one deposition parameter is adjusted in real time while said 3D object is being printed.

67. The method of claim 64, wherein (c) further comprises using one or more sensors to measure said one or more properties of said 3D object.

68. The method of claim 64, wherein said at least one deposition parameter is energy or mass of said 3D object or said at least one feedstock.

69. The method of claim 64, wherein said at least one deposition parameter corresponds to an energy or mass of at least one voxel of said 3D object or said at least one feedstock.

70. The method of claim 64, wherein (d) comprises controlling a mass of said 3D object or said at least one feedstock.

71. The method of claim 64, wherein (d) comprises controlling a deposition rate or mass flow rate during said printing said 3D object.

72. The method of claim 64, wherein said heating is Joule heating.

73. A system for printing a three-dimensional (3D) object adjacent to a base, comprising:
a print head configured to print said 3D object; and
one or more computer processors operatively coupled to said print head, wherein said one or more computer processors are individually or collectively programmed to:
(i) calculate at least one deposition parameter based at least in part on a computational representation of said 3D object;
(ii) direct said print head to initiate printing of said 3D object in accordance with said at least one deposition parameter, wherein said printing comprises subjecting at least one feedstock to heating upon flow of electrical current through said at least one feedstock and into said base, or vice versa, which heating is sufficient to melt at least a portion of said at least one feedstock;
(iii) while printing said 3D object with said print head, (1) measure one or more properties of said 3D object or said at least one feedstock and (2) determine whether said one or more properties of said 3D object measured in (1) meet one or more predetermined properties of said 3D object or said at least one feedstock;
(iv) adjust said at least one deposition parameter upon determining that said one or more properties of said 3D object or said at least one feedstock measured in (iii) do not meet said one or more predetermined properties, to yield at least one adjusted deposition parameter; and
(v) use said print head and said at least one adjusted deposition parameter to continue to print said 3D object.

74. The system of claim 73, wherein said base comprises at least one electrically conductive sheet secured to a support.

75. The system of claim 73, wherein said one or more computer processors are individually or collectively programmed to further generate said one or more predetermined properties by simulating said 3D object.

76. The system of claim 73, wherein said one or more computer processors are individually or collectively programmed to further adjust said at least one deposition parameter in real time while said 3D object is being printed.

77. The system of claim 73, further comprising one or more sensors configured to measure said one or more properties of said 3D object.

78. The system of claim 73, wherein said at least one deposition parameter is energy or mass of said 3D object or said at least one feedstock.

79. The system of claim 73, wherein said at least one deposition parameter corresponds to an energy or mass of at least one voxel of said 3D object or said at least one feedstock.

80. The system of claim 73, wherein said one or more computer processors are individually or collectively programmed to, in (iv), control a mass of said 3D object or said at least one feedstock.

81. The system of claim 73, wherein said one or more computer processors are individually or collectively programmed to, in (iv), control a deposition rate or mass flow rate during said printing of said 3D object.

82. The system of claim 73, wherein said heating is Joule heating.

83. The system of claim 73, further comprising one or more tips configured to shape at least one layer of said 3D object.
